(19) United States
(12) Patent Application Publication
(10) Pub. No.: US 2024/0004208 A1
(43) Pub. Date: Jan. 4, 2024

(54) LASER LIGHT SOURCES AND METHODS

(71) Applicant: Optonomous Technologies, Inc., Agoura Hills, CA (US)

(72) Inventors: Kenneth Li, Agoura Hills, CA (US); Yung Peng Chang, Hsinchu (TW); Lion Wang, Hsinchu (TW); Andy Chen, Taichung (TW); Stark Tsai, Hsinchu (TW); Kirk Huang, Taichung (TW)

(21) Appl. No.: 18/027,555

(22) PCT Filed: Sep. 16, 2021
(86) PCT No.: PCT/US2021/050754

§ 371 Date: Mar. 21, 2023

Related U.S. Application Data
(60) Provisional application No. 63/225,737, filed on Jul. 26, 2021.
(60) Provisional application No. 63/180,026, filed on Apr. 26, 2021.
(60) Provisional application No. 63/081,299, filed on Sep. 21, 2020.

(51) Int. Cl. G02B 27/14; G02B 27/09; G03B 21/20

(52) U.S. Cl. CPC G02B 27/149; G02B 27/0905; G02B 27/141; G03B 21/2013; G03B 21/2033; G03B 21/2066

(57) ABSTRACT

An RGB (red-green-blue) laser light source for projection displays that combines a plurality of beams into a smaller cross-sectional area, optionally co-axially combining beams of different colors, and angularly and spatially homogenizing the result for a collimated output with better etendue. Some embodiments use slotted mirror(s)s and/or wavelength-selective filter-reflectors for combining laser beams from two laser arrays, hexagonal light guide(s) and/or diffuser(s) to homogenize the beam, rotational and/or translational movements of diffuser(s) to reduce speckle contrast, optional turning mirrors to shorten lengths of the structure for use in moving-head stage-light systems. In some embodiments, laser-diode packages are integrated with collimating lenses, reducing the size of the package and the system as a whole.

### CROSS-REFERENCE TO RELATED APPLICATIONS

This application claims priority benefit, including under 35 U.S.C. § 119(e), of
U.S. Provisional Patent Application 63/081,299, filed Sep. 21, 2020 by Yung Peng Chang et al. and titled “Laser light sources”;
U.S. Provisional Patent Application 63/180,026, filed Apr. 26, 2021 by Yung Peng Chang et al. and titled “Laser light sources”; and
U.S. Provisional Patent Application 63/225,737, filed Jul. 26, 2021 by Kenneth Li et al. and titled “RGB laser light sources”; each of which is incorporated herein by reference in its entirety.

### FIELD OF THE INVENTION

This invention relates to the field of laser and light sources, and more specifically to a method and apparatus to increase brightness and etendue of projected light having a plurality of colors by using a plurality of laser light sources of each color to reduce speckle (e.g., a plurality of red lasers, a plurality of green lasers, and a plurality of blue color lasers are provided in some embodiments such that randomness between the lasers of each color reduces speckle contrast), as well as providing output beams that can be variably narrowed or broadened as well as dimmed or brightened while maintaining color purity and saturation across the entire beam for a variable-color spectrum imparted to the beam, all of which are particularly useful for high-power light applications such as concert-stage lighting and the like.

### BACKGROUND OF THE INVENTION

Based on etendue limitations, the maximum brightness output of a non-coherent white light source is not high enough to support many high-output applications. This is especially the case when wavelength-selective colored filters are used, where the filter reflects or absorbs those wavelengths that are not wanted in the colored light output beam. As a result, a direct laser source using red, green, and blue lasers will be needed. However, a laser beam tends to have speckle caused by the mutual interference of a set of coherent wavefronts having different phases and amplitudes, which add together to give a resultant wave whose amplitude at different points in the illuminated field, and therefore intensity at each point, varies randomly. For some applications, speckle is undesirable. One way to measure the amount or degree of speckle is speckle contrast, wherein low speckle contrast is more desirable than high speckle contrast.

This application is related to: —U.S. Provisional Patent Application 62/916,580 titled “Recycling Light System using Total Internal Reflection to Increase Brightness of a Light Source,” filed Oct. 17, 2019, by Kenneth Li;
U.S. Provisional Patent Application 62/763,423 titled “Laser Excited Crystal Phosphor Light Module,” filed Jun. 14, 2018 by Yung Peng Chang et al.,
U.S. Provisional Patent Application 62/764,085 titled “Laser Excited Crystal Phosphor Light Source with Side Excitation,” filed Jul. 18, 2018 by Yung Peng Chang et al.,
U.S. Provisional Patent Application 62/764,090 titled “Laser Excited RGB Crystal Phosphor Light Source,” filed Jul. 18, 2018 by Yung Peng Chang et al.,
U.S. Provisional Patent Application 62/766,209 titled “Laser Phosphor Light Source for Intelligent Headlights and Spotlights,” filed Oct. 5, 2018 by Yung Peng Chang et al.,
PCT Patent Application No. PCT/US2020/037669, titled “HYBRID LED/LASER LIGHT SOURCE FOR SMART HEADLIGHT APPLICATIONS,” filed Jun. 14, 2020 by Kenneth Li et al. (published Dec. 24, 2020 as WO 2020/257091),
U.S. Provisional Patent Application 62/862,549 titled “ENHANCEMENT OF LED INTENSITY PROFILE USING LASER EXCITATION,” filed Jun. 17, 2019, by Kenneth Li;
U.S. Provisional Patent Application 62/874,943 titled “ENHANCEMENT OF LED INTENSITY PROFILE USING LASER EXCITATION,” filed Jul. 16, 2019, by Kenneth Li;
U.S. Provisional Patent Application 62/938,863 titled “DUAL LIGHT SOURCE FOR SMART HEADLIGHT APPLICATIONS,” filed Nov. 21, 2019, by Y. P. Chang et al.;
U.S. Provisional Patent Application 62/954,337 titled “HYBRID LED/LASER LIGHT SOURCE FOR SMART HEADLIGHT APPLICATIONS,” filed Dec. 27, 2019, by Kenneth Li;
PCT Patent Application No. PCT/US2020/034447, filed May 24, 2020 by Y. P. Chang et al., titled “LiDAR INTEGRATED WITH SMART HEADLIGHT AND METHOD” (published Dec. 3, 2020 as WO 2020/243038);
U.S. Provisional Patent Application No. 62/853,538, filed May 28, 2019 by Y. P. Chang et al., titled “LIDAR Integrated With Smart Headlight Using a Single DMD”;
U.S. Provisional Patent Application No. 62/857,662, filed Jun. 5, 2019 by Chun-Nien Liu et al., titled “Scheme of LIDAR-Embedded Smart Laser Headlight for Autonomous Driving”;
U.S. Provisional Patent Application No. 62/950,080, filed Dec. 18, 2019 by Kenneth Li, titled “Integrated LIDAR and Smart Headlight using a Single MEMS Mirror”;
PCT Patent Application PCT/US2019/037231 titled “ILLUMINATION SYSTEM WITH HIGH INTENSITY OUTPUT MECHANISM AND METHOD OF OPERATION THEREOF,” filed Jun. 14, 2019, by Y. P. Chang et al. (published Jan. 16, 2020 as WO 2020/013952);
U.S. patent application Ser. No. 16/509,085 titled “ILLUMINATION SYSTEM WITH CRYSTAL PHOSPHOR MECHANISM AND METHOD OF OPERATION THEREOF,” filed Jul. 11, 2019, by Y. P. Chang et al. (published Jan. 23, 2020 as US 2020/0026169);
U.S. Pat. No. 10,754,236 titled “ILLUMINATION SYSTEM WITH HIGH INTENSITY PROJECTION MECHANISM AND METHOD OF OPERATION THEREOF,” issued Aug. 25, 2020 to Y. P. Chang et al.;
U.S. Provisional Patent Application 62/837,077 titled “LASER EXCITED CRYSTAL PHOSPHOR SPHERE LIGHT SOURCE,” filed Apr. 22, 2019, by Kenneth Li et al.;
U.S. Provisional Patent Application 62/853,538 titled “LIDAR INTEGRATED WITH SMART HEADLIGHT USING A SINGLE DMD,” filed May 28, 2019, by Y. P. Chang et al.;
U.S. Provisional Patent Application 62/856,518 titled “VERTICAL CAVITY SURFACE EMITTING LASER USING DICHROIC REFLECTORS,” filed Jul. 8, 2019, by Kenneth Li et al.;
U.S. Provisional Patent Application 62/871,498 titled “LASER-EXCITED PHOSPHOR LIGHT SOURCE AND METHOD WITH LIGHT RECYCLING,” filed Jul. 8, 2019, by Kenneth Li;
U.S. Provisional Patent Application 62/857,662 titled “SCHEME OF LIDAR-EMBEDDED SMART LASER HEADLIGHT FOR AUTONOMOUS DRIVING,” filed Jun. 5, 2019, by Chun-Nien Liu et al.;
U.S. Provisional Patent Application 62/873,171 titled “SPECKLE REDUCTION USING MOVING MIRRORS AND RETRO-REFLECTORS,” filed Jul. 11, 2019, by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING,” filed Aug. 1, 2019, by Kenneth Li;
U.S. Provisional Patent Application 62/895,367 titled “INCREASED BRIGHTNESS OF DIFFUSED LIGHT WITH FOCUSED RECYCLING,” filed Sep. 3, 2019, by Kenneth Li;
U.S. Provisional Patent Application 62/903,620 titled “RGB LASER LIGHT SOURCE FOR PROJECTION DISPLAYS,” filed Sep. 20, 2019, by Lion Wang et al.; and
PCT Patent Application No. PCT/US2020/035492, filed Jun. 1, 2020 by Kenneth Li et al., titled “VERTICAL-CAVITY SURFACE-EMITTING LASER USING DICHROIC REFLECTORS” (published Dec. 13, 2020 as WO 22020/247291); each of which is incorporated herein by reference in its entirety.

There is a need in the art for increased brightness and etendue of projected light having a plurality of colors while avoiding and/or reducing speckle normally associated with laser sources.

### SUMMARY OF THE INVENTION

The present invention provides a method and apparatus for increasing brightness and etendue of projected light having a plurality of colors while avoiding and/or reducing speckle normally associated with laser sources. To overcome the speckle issues related to the coherence nature of the lasers, multiple lasers are used in the present invention such that the randomness between the plurality of laser beams reduces the speckle contrast.

In some embodiments, the present invention provides an apparatus that includes: a first plurality of lasers emitting a first plurality of parallel input laser beams, each having a first color, propagating in a first direction and spaced apart by a first beam-to-beam spacing and having a first total cross-sectional area; a second plurality of lasers emitting a second plurality of parallel input laser beams of one or more colors, other than the first color, propagating in a second direction and spaced apart by a second beam-to-beam spacing and having a second total cross-sectional area; a beam combiner that combines the first plurality of parallel input laser beams and the second plurality of parallel input laser beams into a first plurality of output laser beams having a cross-sectional area less than the first total cross-sectional area plus the second total cross-sectional area; and first homogenizer optics configured to combine the first plurality of laser beams into a single homogenized light beam. In some embodiments, the beam combiner includes a first wavelength-selective filter-reflector configured to transmit the first plurality of parallel input laser beams and to reflect the second plurality of parallel input laser beams such that each of the first plurality of output laser beams is a coaxial combination of one of the first plurality of parallel input laser beams with a corresponding one of the second plurality of parallel input laser beams.

In some embodiments, the present invention provides combinations of one or more of the following features: wavelength-selective filter-reflectors and/or broadband reflectors used to co-axially combine a plurality of laser beams of different colors or wavelengths, stepped reflectors used to reduce the spacings between adjacent parallel laser beams (including stepped reflectors having reflector spacings that correspond to a smaller cross-sectional width of asymmetric laser-beam cross-sectional dimensions and stepped reflectors that receive input laser beams in one-dimensional arrays and form parallel output beams in two-dimensional arrays), light pipes, fused fiber bundles and/or diffusers that spatially and/or angularly homogenize a plurality of laser beams.

Some embodiments use one or more slotted mirrors for combining laser beams from two laser arrays. In some embodiments, a hexagonal light guide is used to homogenize the beam, which is superior to beams formed using rectangular or round light guides for a round-output application. In some embodiments, diffusers are used to provide better uniformity of the output profile and are placed at the parallel part of the light-beam path. In some embodiments, rotational and/or translational movements are introduced to the diffuser(s) for the reduction of speckle contrast. In some embodiments, a turning mirror is used to shorten the overall length of the structure, making it suitable for use in moving-head stage-light systems. In some embodiments, laser-diode packages are integrated with collimating lenses, reducing the size of the package and the system as a whole.

### BRIEF DESCRIPTION OF THE DRAWINGS

FIG. 1 is a perspective view of a light source 101, according to some embodiments of the present invention.

FIG. 2 is a block diagram cross-section view of a laser assembly 201 having a plurality of laser-lens pairs, each laser having the same color, according to some embodiments of the present invention.

FIG. 3 is a block diagram cross-section view of a laser assembly 301 having a plurality of laser-lens pairs, according to some embodiments of the present invention.

FIG. 4 is a block diagram cross-section view of a laser-combiner assembly 401 having a laser assembly 301, a reflector 451 and a wavelength-selective filter-reflector 452, according to some embodiments of the present invention.

FIG. 5 is a block diagram cross-section view of a laser-combiner assembly 501 having two laser assemblies 301A and 301B, a wavelength-selective filter-reflector 551 and a wavelength-selective filter-reflector 552, according to some embodiments of the present invention.

FIG. 6 is a block diagram cross-section view of a laser-combiner assembly 601 having three laser assemblies 201A, 201B and 201C, and four wavelength-selective filter-reflectors 671, 672, 673, and 674, according to some embodiments of the present invention.

FIG. 7A is a block diagram cross-section view of a laser-combiner assembly 701 having two laser assemblies 301A and 301B, according to some embodiments of the present invention.

FIG. 7B is a block diagram cross-section view of a laser-combiner assembly 702 having two laser assemblies 301A and 301B, and four wavelength-selective filter-reflectors, according to some embodiments of the present invention.

FIG. 7C is a block diagram cross-section view of a laser-combiner assembly 703 having two laser assemblies 301A and 301B, two reflectors 791 and 798, and two wavelength-selective filter-reflectors 795 and 796, according to some embodiments of the present invention.

FIG. 7D is a block diagram cross-section view of a laser-combiner assembly 704 having two laser assemblies 301A and 301B, two reflectors 771 and 772, and four wavelength-selective filter-reflectors 773, 774, 775 and 776, according to some embodiments of the present invention.

FIG. 7E is a block diagram cross-section view of a laser-combiner assembly 705 having two laser assemblies 201R and 301BG, two reflectors 791 and 798, and two wavelength-selective filter-reflectors 776 and 797, according to some embodiments of the present invention.

FIG. 8 is a block diagram cross-section view of a laser-homogenizer assembly 801 having a light pipe, a plurality of lenses, and one or more optional diffusers, according to some embodiments of the present invention.

FIG. 9A is a block diagram cross-section view of a laser-combiner assembly 901 having two input laser beams 917 and 918 entering fused fiber bundle 910 at two different angles, wherein output beam 919 has a larger spread angle for the laser beam entering fused fiber bundle 910 from a larger angle, according to some embodiments of the present invention.

FIG. 9B is a front view of a laser-beam output pattern 902 resulting from output beam 919 of FIG. 9A being projected against a flat surface 925, according to some embodiments of the present invention.

FIG. 9C is a block diagram cross-section view of a laser-combiner assembly 903 having a plurality of input laser beams 931-937 (in this example case, seven beams) focused and entering fused fiber bundle 910 at a plurality of different angles, wherein output beam 939 has a larger spread angle for the laser beam(s) entering fused fiber bundle 910 from a larger angle, according to some embodiments of the present invention.

FIG. 9D is a front view of a laser-beam output pattern 904 resulting from output beam 939 of FIG. 9C being projected against a flat surface 925, according to some embodiments of the present invention.

FIG. 9E is a block diagram cross-section view of a laser-combiner assembly 905 having a plurality of input laser beams 931-937 (in this example case, seven beams) focused and entering fused fiber bundle 911 at a plurality of different angles, wherein the output of fused fiber bundle 911 is directed through light pipe 912 and then diffuser 913 to form output beam 959, according to some embodiments of the present invention.

FIG. 9F is a block diagram cross-section view of a laser-combiner assembly 906, according to some embodiments of the present invention.

FIG. 10A is a block diagram cross-section view of a laser-combiner assembly 1001 having two fused fiber bundles 1014 and 1016 spaced apart by light pipe 1015, such that light from fiber bundle 1014 is homogenized by light pipe 1015 and enters fiber bundle 1016, whose output is further homogenized by light pipe 1017 to form output beam 1019, according to some embodiments of the present invention.

FIG. 10B is a block diagram cross-section view of a laser-combiner assembly 1002 having two fused fiber bundles 1024 and 1026 each having sloped (angled) interface surfaces and spaced apart by light pipe 1025, such that light from fiber bundle 1024 exists at an angle to optical axis 1099 and is homogenized by light pipe 1025 and enters the angled input face of fiber bundle 1026, whose output is further homogenized by light pipe 1027 to form output beam 1029, according to some embodiments of the present invention.

FIG. 10C is a block diagram cross-section view of a laser-combiner assembly 1003 having two fused fiber bundles 1034 and 1036, each having perpendicular interface surfaces arranged at an angle to one another to form output beam 1039, according to some embodiments of the present invention.

FIG. 10D is a block diagram cross-section view of a laser-combiner assembly 1004 having one fused fiber bundle 1044 having perpendicular interface surfaces and a light pipe 1045 having an output face at a non-perpendicular angle to the light from fused fiber bundle 1044 to form angled output beam 1049, according to some embodiments of the present invention.

FIG. 10E is a block diagram cross-section view of a laser-combiner assembly 1005 having one fused fiber bundle 1044 having perpendicular interface surfaces and a light pipe 1045 having an output face at a non-perpendicular angle to the light from fused fiber bundle 1044, which has its output light coupled through fused fiber bundle 1056, light pipe 1057 and diffuser 1058 to form output beam 1059, according to some embodiments of the present invention.

FIG. 10F is a block diagram cross-section view of a laser-combiner assembly 1006 having two sets of fused fiber bundle 1044 and light pipe 1045, each having its output face at a non-perpendicular angle to the light from fused fiber bundle 1044, which are sequentially positioned to have their output coupled through fused fiber bundle 1056, light pipe 1057 and diffuser 1058 to form output beam 1069, according to some embodiments of the present invention.

FIG. 11A is a block diagram plan view of a striped reflector 1101 having a plurality of reflective stripes 1117 alternating with a plurality of transparent stripes 1118, according to some embodiments of the present invention.

FIG. 11B is a block diagram cross-section view from a first direction of a laser-combiner assembly 1102 having two banks of similar-colored lasers 1110G and 1112G directed at striped reflector 1101, and two banks of different-colored lasers 1110B and 1110R directed at a wavelength-selective reflector-filter reflector 1171, according to some embodiments of the present invention.

FIG. 11C is block diagram cross-section elevation view from a second direction (perpendicular to the first direction of FIG. 11B) of laser-combiner assembly 1102, according to some embodiments of the present invention.

FIG. 12A is a block diagram perspective view of an angled reflector 1201 made from a rectangular rod 1210 having a highly reflective angled-end surface 1211, according to some embodiments of the present invention.

FIG. 12B is a block diagram cross-section view of a laser-beam-combiner assembly 1202 having a laser bank 1213 that includes a plurality of, e.g., four, lasers 1214 directed at a stepped angle reflector 1212, according to some embodiments of the present invention.

FIG. 12C is a block diagram plan view of an arrayed laser bank 1203 having a plurality of columns and a plurality of rows of lasers 1214 that output similarly-colored laser beams, according to some embodiments of the present invention.

FIG. 12D is a block diagram end view, partially in cross-section, of a laser-beam combiner assembly 1204 having a laser bank 1213 that includes a plurality of lasers 1214 (e.g., in some embodiments, eight lasers) directed at two stepped angle reflectors 1212, according to some embodiments of the present invention.

FIG. 12E is a block diagram end view, partially in cross-section, of a laser-beam combiner assembly 1205 having two laser banks 1213B and 1213G that each includes a plurality of lasers 1214 (e.g., in some embodiments, eight lasers), each directed at two stepped angle reflectors 1212, according to some embodiments of the present invention.

FIG. 12F is a block diagram side view, partially in cross-section, of laser-beam combiner assembly 1205 having two laser banks 1213B and 1213G that each includes a plurality of lasers 1214, each directed at two stepped angle reflectors 1212, according to some embodiments of the present invention.

FIG. 12G is a block diagram plan view of an arrayed laser bank 1207 having a plurality of columns and a plurality of rows of lasers 1214 that output different-colored laser beams, according to some embodiments of the present invention.

FIG. 12H is a block diagram end view, partially in cross-section, of a laser-beam combiner assembly 1208 having two laser banks 1213 that each includes a plurality of, e.g., eight, lasers 1214 that output different-colored laser beams directed at two stepped angle reflectors 1212, according to some embodiments of the present invention.

FIG. 13A is a block diagram perspective view of an angled transparent reflector 1301 made from a rectangular transparent rod 1310 having a highly reflective angled-end surface 1311, according to some embodiments of the present invention.

FIG. 13B is a block diagram cross-section view of a laser-beam combiner assembly 1302 having a laser bank 1213 that includes a plurality of, e.g., four, lasers 1214 directed at a stepped angle reflector 1312, according to some embodiments of the present invention.

FIG. 14A is an exploded perspective view block diagram of a laser-beam reflector assembly 1401 having four end reflectors and optionally having side reflectors, according to some embodiments of the present invention.

FIG. 14B is a perspective view block diagram, partially in cross section, of a laser-beam reflector combiner assembly 1402 having four end reflectors and optionally having side reflectors, and four input lasers 1213, according to some embodiments of the present invention.

FIG. 14C is a plan view block diagram, partially in cross section, of laser-beam reflector combiner assembly 1402 having four end reflectors and optionally having side reflectors, and four input lasers 1213, according to some embodiments of the present invention.

FIG. 14D is a perspective view block diagram of a laser-beam reflector assembly 1404 having four end reflectors and optionally having side reflectors, and four input lasers 1213, according to some embodiments of the present invention.

FIG. 14E is a plan view block diagram, partially in cross section, of laser-beam reflector combiner assembly 1405 having eight end reflectors and optionally having side reflectors, and eight input lasers 1213G and 1213R, according to some embodiments of the present invention.

FIG. 14F is a side view block diagram, partially in cross section, of laser-beam combiner assembly 1406, according to some embodiments of the present invention.

FIG. 15A is a side view block diagram of a moving head spot light 1501, according to some embodiments of the present invention.

FIG. 15B is a side view block diagram of a ultra-long-range laser spotlight 1502, according to some embodiments of the present invention.

### DETAILED DESCRIPTION OF PREFERRED EMBODIMENTS OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Based on etendue limitations, the maximum brightness output of a non-coherent white light source is not high enough to support many high-output applications. As a result, a direct laser source using red, green, and blue lasers will be needed. To overcome the speckle issues related to the coherence nature of the lasers, multiple lasers are used such that the randomness between the lasers reduces the speckle contrast.

With the advancements in making laser diodes in various colors, it becomes possible to generate various light outputs using a combination of such laser diodes. Laser diodes provide well-collimated beams, providing superior efficiency and directivity. Together with wavelength-conversion materials, beams having various colors of light, including white light, can be obtained.

In some embodiments, there are several features combined into this invention, making this invention uniquely advantageous over other designs:
For each color, an array of lasers is used to increase power and reduce speckles.
In some embodiments, one or more slotted mirrors are used for combining laser beams from two laser arrays.
In some embodiments, a hexagonal light guide is used to homogenize the beam, which is superior to beams formed using rectangular or round light guides for a round-output application.
In some embodiments, diffusers are used to provide better uniformity of the output profile and are placed at the parallel part of the light-beam path. In some embodiments, rotational and/or translational movements are introduced to the diffuser(s) for the reduction of speckle contrast.
In some embodiments, a turning mirror is used to shorten the overall length of the structure, making it suitable for use in moving-head stage-light systems.
In some embodiments, laser-diode packages are integrated with collimating lenses, reducing the size of the package and the system as a whole.

Direct multi-color laser light sources have many advantages over comparable white-light and color-light sources, as they can be made much brighter and have more saturated colors. In addition, they can be focused onto small-etendue devices with high efficiency. The challenge is to provide a cost-effective and efficient system combining the outputs of the various color lasers into a single collinear beam such that the etendue is not increased. This invention discloses an efficient and cost-effective method for combining lasers of the same color and/or different colors into a single collinear output beam, which can be used for various applications such as projectors, stage-lighting light sources, GOBO projectors, etc. Note that a “GOBO” (which stands for ‘goes before optics’ {credit: medium.com}) is typically a stencil or template placed inside or in front of a light source to control the shape of the emitted light. Lighting designers typically use GOBO devices with stage-lighting instruments (credit: en.wikipedia.org/wiki/Stage_lighting_instrument) to manipulate the shape of the light cast over a space or object—for example to produce a pattern of leaves on a stage floor (Wikipedia).

The output of the typical laser diode has a very asymmetric output divergence, with divergence in one direction in the region of ten (10) degrees, and divergence of about forty (40) degrees in another (e.g., perpendicular) direction. In some embodiments of the present invention, an asymmetric collimating lens is placed in front of the laser package such that the output is a beam of light with narrow divergences in both directions. In some embodiments, the laser diode is packaged individually in a transistor-outline (TO) package, and the laser-diode package(s) is/are soldered to the heat sink, which is attached to the base of the TO-package. The laser output beam can be collected from a window of the TO-package. To provide a parallel-beam output, in some embodiments a collimating lens is placed in front of the laser diode such that the laser diode emission area is at the focus of the collimating lens. This collimating lens can also replace the window of the TO-package, as appropriate. Since the divergences of the laser diode are not symmetric, if a standard lens is used, the output parallel beam has an elliptical cross-section, i.e., wider in one direction and narrower in the other direction. If a circular beam is required, a cylindrical or other asymmetric lens system is required, which would add cost to the system.

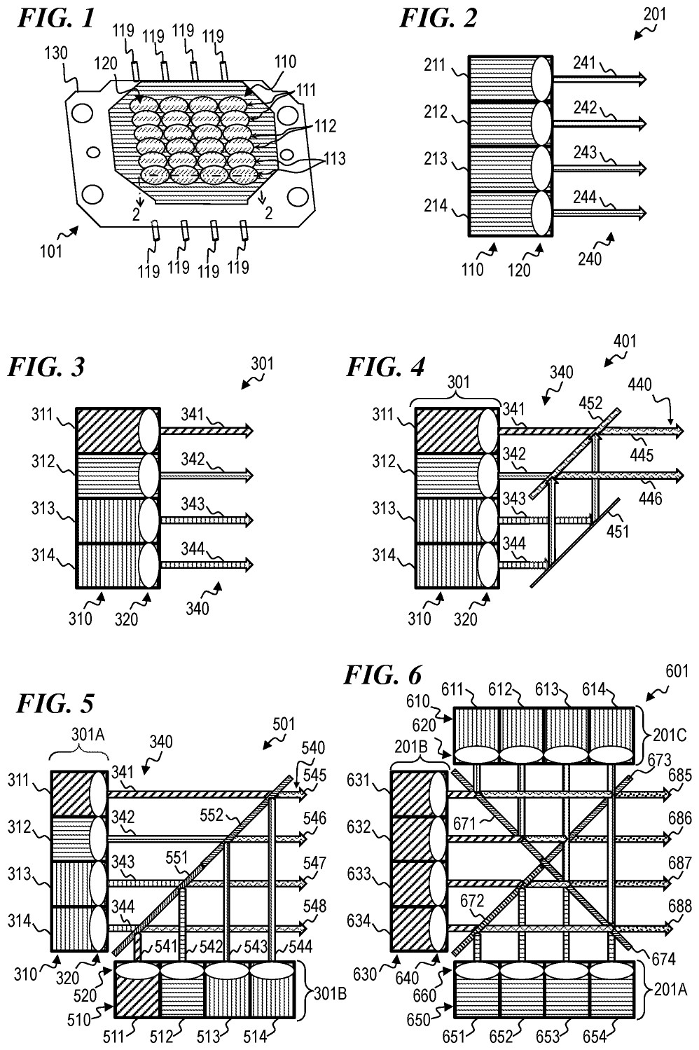

FIG. 1 is a perspective view of a light source 101 having a plurality of lasers 110 that, in some embodiments, includes a plurality of red color lasers 111, a plurality of green color lasers 112, and a plurality of blue color lasers 113, in order that the inherent randomness between the lasers of each color reduces speckle contrast, according to some embodiments of the present invention. In some embodiments, the plurality of lasers 110 is mounted on a heatsink 130, and a plurality of electrical conductors 119 supply selectively controlled electrical power to the lasers 110 to control timing and/or brightness of the individual lasers such that a desired amount of each color is output when desired. In some embodiments, each one of the plurality of lasers 110 is associated with a respective one of a plurality of lenses or lenslets 121 of a lens array 120 (shown here located at the ends of lasers 111, 112, and 113). In some embodiments, each respective one of the plurality of lenses or lenslets 121 is used to collimate the respective laser beam from its respective one of the plurality of lasers 110. Cross-section cut line 2 indicates the cross-section view of FIG. 2.

Light source 101 includes a two-dimensional laser array in which the laser diodes 110 are mounted inside a rectangular two-dimensional array package having heat sink 130. In some embodiments, as shown in this particular example of FIG. 1, light source 101 is a 4×6 array with four columns, and each column has six laser diodes, giving a total of twenty-four laser diodes. In other embodiments, laser arrays having other numbers of rows and columns are used, such as a 2×2 array, a 2×3 array, a 2×4 array, a 2×5 array, a 2×6 array, a 3×3 array, a 3×4 array, a 3×5 array, a 3×6 array, a 4×4 array, a 4×6 array, or other array sizes. In some embodiments, the lasers 110 are not arranged in straight row-and-column arrangements, but some rows or columns are offset or staggered. In some embodiments, single-color arrays are used, while in other embodiments, a plurality of colors in a single array are used. To extract the output from the laser diodes effectively, a matching two-dimensional collimating-lens array 120 is provided, with lenslets 121 of lens array 120 matched to the positions of the laser diodes. Lens array 120 is placed on top of the laser diodes 110 such that each lenslet 121 captures the output from the corresponding laser diode and outputs a collimated laser beam. In some embodiments, the output from lens array 120 is an array of parallel laser beams (e.g., such as beam array 240 shown in FIG. 2), which can be directed towards the targeted optical system.

FIG. 2 is a block diagram cross-section side view of a laser assembly 201 having a plurality of (e.g., in some embodiments, four) laser-lens pairs (e.g., in some embodiments, four laser-lens pairs 211, 212, 213 and 214), each one of the plurality of lasers 110 having the same color and each having a respective one of the plurality of collimating lenses 121 of a lens array 120, according to some embodiments of the present invention. In some embodiments, laser assembly 201 has a plurality of rows and a plurality of columns, such as shown in FIG. 1. For example, in some embodiments, the block diagram cross-section view of FIG. 2 represents one row of four blue lasers (wherein the horizontal cross-hatched pattern applied in some of the patent figures herein indicates blue lasers and/or beams) and their respective lenses and output beams as viewed on cross-section cut line 2 of FIG. 1. In some embodiments, laser assembly 201 includes a plurality of lasers 110 and corresponding a plurality of lenses 121 arranged in pairs, wherein laser-lens pair 211 outputs collimated laser beam 241, laser-lens pair 212 outputs collimated laser beam 242, laser-lens pair 213 outputs collimated laser beam 243, and laser-lens pair 214 outputs collimated laser beam 244. In some other embodiments, each row of lasers includes lasers that output laser beams that all have the same color, or a plurality of different color laser beams, such as, for example, two laser beams having red color, one blue laser beam and one green laser beam. In some such embodiments, red lasers output less power and brightness than green lasers or blue lasers, so a greater number of red lasers are used to compensate for their lower brightness. Further, when a laser bank such as laser assembly 201 is composed of four TO-packaged laser diodes with collimating lenses arranged in a line along one dimension, each TO-package is soldered or glued to a heat sink (such as shown in FIG. 1), and the output of each row will be four parallel beams spaced apart by the physical dimensions of the TO-packages, as shown in FIG. 2 and FIG. 3. While such spacing lowers the combined power density per unit of cross-sectional area of the output beams and allows better heat dissipation, in some embodiments it is desirable to reduce the optical spacings between the individual laser beams 240 and 340.

FIG. 3 is a block diagram cross-section view of a laser assembly 301 having a plurality of laser-lens pairs, wherein a first laser 311 has a first color (e.g., in some embodiments, green, wherein the lower-left-to-upper-right diagonal cross-hatched pattern applied in some of the patent figures herein indicates green lasers and/or beams) a second laser 312 has a different second color (e.g., in some embodiments, blue, wherein the horizontal cross-hatched pattern applied in some of the patent figures herein indicates blue lasers and/or beams), and the other two lasers 313 and 314 have the same third color (e.g., in some embodiments, red, wherein the vertical cross-hatched pattern applied in some of the patent figures herein indicates red lasers and/or beams) that is different than the first color and the second color, according to some embodiments of the present invention. In other embodiments, lasers that emit other colors than those indicated in this figure are used, with corresponding changes being made to other wavelength-sensitive optical elements. In some embodiments, laser-lens pair 311 outputs collimated green laser beam 341, laser-lens pair 312 outputs collimated blue laser beam 342, laser-lens pair 313 outputs collimated red laser beam 343, and laser-lens pair 314 outputs collimated red laser beam 344. In some embodiments, the cross-section view of laser assembly 301 in FIG. 3 represents just one of a plurality of rows of similar sets of laser-lens pairs.

FIG. 4 is a block diagram cross-section view of a laser-combiner assembly 401 having a laser assembly 301, a reflector 451 and a wavelength-selective filter-reflector 452, according to some embodiments of the present invention. In some embodiments, the two collimated red laser beams 343 and 344 are each reflected upward by mirror/reflector 451, and the two collimated red laser beams 343 and 344 are then each reflected rightward by wavelength-selective filter-reflector 452, which reflects red wavelengths and passes the green and blue wavelengths of laser beams 341 and 342, respectively. Thus, green+red output beam 445 is the combination of the portion of green laser beam 341 that is transmitted by wavelength-selective filter-reflector 452 and the portion of red laser beam 343 that is reflected by wavelength-selective filter-reflector 452. Similarly, blue+red output beam 446 is the combination of the portion of blue laser beam 342 that is transmitted by wavelength-selective filter-reflector 452 and the portion of red laser beam 344 that is reflected by wavelength-selective filter-reflector 452. In some embodiments, the cross-section view of laser-combiner assembly 401 in FIG. 4 represents just one of a plurality of rows of similar sets of laser-lens pairs and just one portion of mirror/reflector 451, and wavelength-selective filter-reflector 452. In other embodiments, lasers that emit other colors than those indicated in this figure are used, with corresponding changes being made to wavelength-selective filter-reflector 452 and other wavelength-sensitive optical elements of the system. By making the system smaller and more efficient in terms of spot size and divergence angle, the outputs can be combined using reflector 451 and wavelength-selective reflector 452 such that the red, blue and green can be directed to a common path, reducing the cross-section area of the overall beam. With laser-combiner assembly 401, the total output cross-section area is reduced to half of the original area. The output beams 344 and 343 of the red laser diodes 314 and 313 are reflected twice to be coaxial with the green beam 341 and blue beam 342 and combined using filter-reflector 452, which transmits blue and green, and reflects red. The output beams 445 and 446 are composed of coaxially overlapping the red beams with the green and blue beams.

FIG. 5 is a block diagram cross-section view of a laser-combiner assembly 501 having two laser assemblies 301A and 301B (each substantially similar to laser assembly 301 of FIG. 3), a wavelength-selective filter-reflector 551 and a wavelength-selective filter-reflector 552, according to some embodiments of the present invention. In some embodiments, each of the two RRGB (red-red-green-blue) laser assemblies 301A and 301B shown in cross-section here represents one row of a respective laser bank, each having a plurality of such rows. In some embodiments, wavelength-selective filter-reflector 551 transmits the red wavelengths of red laser beam 344 and reflects the green wavelengths of green laser beam 541 to form green+red output beam 548 and transmits the red wavelengths of red laser beam 343 and reflects the blue wavelengths of blue laser beam 542 to form blue+red output beam 547. Conversely, wavelength-selective filter-reflector 552 reflects the red wavelengths of red laser beam 544 and transmits the green wavelengths of green laser beam 541 to form green+red output beam 545, and reflects the red wavelengths of red laser beam 543 and transmits the blue wavelengths of blue laser beam 543 to form blue+red output beam 546. In other embodiments, lasers that emit other colors than those indicated in this figure are used, with corresponding changes being made to wavelength-selective filter-reflectors 551 and 552, as well as other wavelength-sensitive optical elements of the system. Laser-combiner assembly 501 combines light from RRGB laser arrays 301A and 301B to produce one output beam 540 having four parallel-columns portions 545, 546, 547 and 548. The two laser assembly arrays 301A and 301B are placed on opposite sides, 90 degrees from one another, of the composite filter 551 and 552 in which half 551 transmits red and reflects blue and green, and the other half 552 reflects red and transmits blue and green. As shown in FIG. 5, the two red outputs of each array combine with the blue and green of the other array. Together, both arrays, each with four columns, when combined, produce an output with a width of four columns of coaxial laser beams, reducing the cross-section area of the combined output 540.

FIG. 6 is a block diagram cross-section view of a laser-combiner assembly 601 having three laser assemblies 201A, 201B and 201C, and four wavelength-selective filter-reflectors 671, 672, 673, and 674, according to some embodiments of the present invention. In some embodiments, laser assemblies 201A, 201B and 201C each has four lasers that output the same color (e.g., in some embodiments, laser assembly 201A outputs four red laser beams, laser assembly 201B outputs four green laser beams, and laser assembly 201C outputs four blue laser beams). In some embodiments, wavelength-selective filter-reflector 671 reflects the red laser beams from red lasers 611 and 612 and transmits the green laser beams from green lasers 631 and 632, and the two resulting red+green beams are transmitted by wavelength-selective filter-reflector 673, which also reflects the blue laser beams from blue lasers 653 and 654, to form red+green+blue output beams 685 and 686. Also, wavelength-selective filter-reflector 672 reflects the blue laser beams from blue lasers 651 and 652 and transmits the green laser beams from green lasers 633 and 634, and the resulting blue+green beams are transmitted by wavelength-selective filter-reflector 674, which also reflects the red laser beams from red lasers 613 and 614, to form red+green+blue output beams 687 and 688. In some embodiments, laser-combiner assembly 501 uses one laser-diode array of each color (red, green, and blue) such that the output parallel beams from each array are combined using a standard dichroic X-Cube or X-Plate. Such X-Cube or X-Plate has two crossed coated filters or four wavelength-selective filter-reflectors 671, 672, 673, and 674. The diagonal filters are coated selectively such that the two colors are combined into a single output with the same four-column width as in each laser-diode array 201A, 201B and 201C. In other embodiments, lasers that emit other colors than those indicated in this figure are used, with corresponding changes being made to wavelength-selective filter-reflectors 671, 672, 673 and 674, as well as other wavelength-sensitive optical elements of the system.

In most cases, green and blue TO-packaged lasers have a small divergence angle and the red TO-packaged lasers have a larger divergence angle. To allow the RGB output to have the same divergences for all the colors, in some embodiments, an optional diffuser is placed at the output of the green and blue lasers before combining with the red output. If the green and blue outputs also have different divergences, another diffuser can be added in the paths of the green laser beams or blue laser beams, so as to match all the divergences.

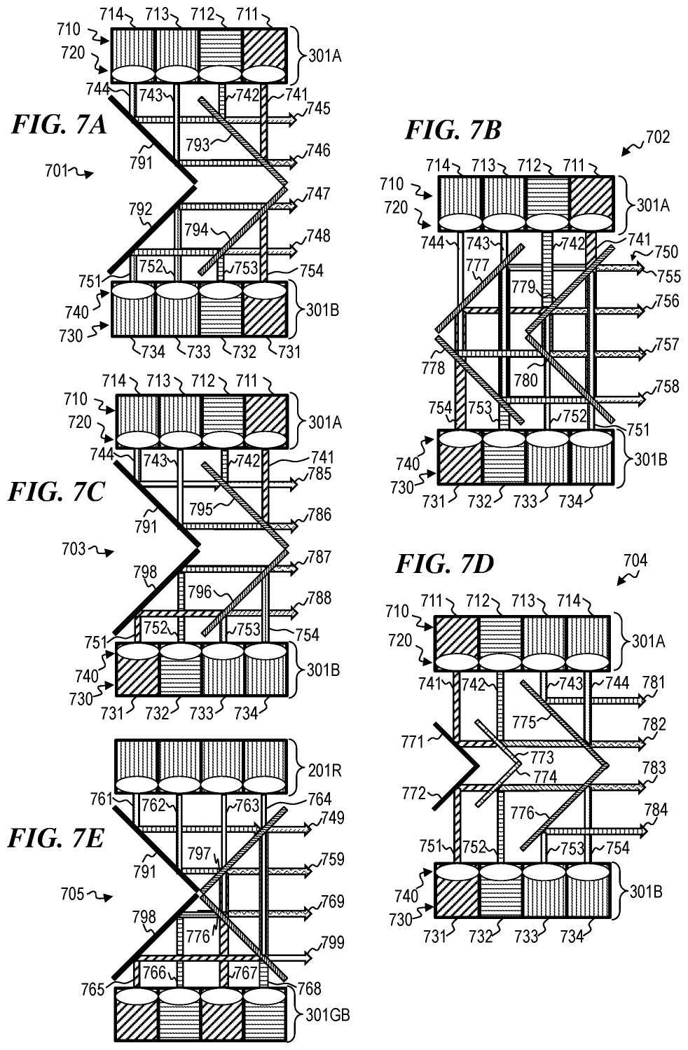

In the embodiments of FIG. 4, FIG. 5 and FIG. 6, (as well as FIGS. 7A-7E and all of the other laser-beam combiner systems described below) the output perceived color (e.g., hue and saturation) is selectively changed by adjusting the output intensity of each input color using the current control (e.g., DC current or pulse-width modulation (PWM)) to the laser diodes of the system.

FIG. 7A is a block diagram cross-section view of a laser-combiner assembly 701 having two multi-color laser assemblies 301A and 301B, two reflectors 791 and 792 that are each highly reflective to at least red wavelengths, and two wavelength-selective filter-reflectors 793 and 794 that each selectively transmit red wavelengths and selectively reflect blue and green wavelengths, according to some embodiments of the present invention. In some embodiments, multi-color laser assembly 301A includes two red lasers 714 and 713 that emit red laser beams 744 and 743, respectively, and filter-reflector 793 passes the reflected red laser beam 744 and reflects the blue laser beam 742 from blue laser 712 to form red+blue coaxial output beam 745, and filter-reflector 793 passes the reflected red laser beam 743 and reflects the green laser beam 741 from green laser 711 to form red+green coaxial output beam 746. Similarly, filter-reflector 794 passes the reflected red laser beam 751 from laser 734 and reflects the blue laser beam 753 from blue laser 732 to form red+blue coaxial output beam 748, and filter-reflector 794 passes the reflected red laser beam 752 from laser 733 and reflects the green laser beam 754 from green laser 731 to form red+green coaxial output beam 747. Laser-combiner assembly 701 uses two planar mirrors 791 and 792 of the same type and two wavelength-selective filter-reflectors 793 and 794 of the same type are used for combining the colors. This reduces the number of different components and further reduce the cost of assembly 701 as compared to assemblies 702, 703, and 705 described below.

FIG. 7B is a block diagram cross-section view of a laser-combiner assembly 702 having two laser assemblies 301A and 301B, and four wavelength-selective filter-reflectors 777, 778, 779 and 780 according to some embodiments of the present invention. In some embodiments, multi-color RRGB laser assembly 301A includes two red lasers 714 and 713 that emit red laser beams 744 and 743, respectively, and filter-reflector 777 passes the downward red laser beams 744 and 743 and reflects the upward green laser beam 754 from green laser 731 to form a horizontal green beam that passes through filter-reflector 779 and is coaxially combined with the red beam 752 that is reflected by filter-reflector 779 to form coaxial red+green output beam 756. The upward blue laser beam 753 horizontally reflected by filter-reflector 777 passes through filter-reflector 779 and is coaxially combined with the reflected red laser beam 751 to form red+blue output beam 755. The downward red laser beam 744 horizontally reflected by filter-reflector 778 passes through filter-reflector 780 and coaxially combines with the reflected downward blue laser beam 742 horizontally reflected by filter-reflector 780 to form red+blue output beam 757. The downward red laser beam 743 horizontally reflected by filter-reflector 778 passes through filter-reflector 780 and coaxially combines with the reflected downward green laser beam 741 horizontally reflected by filter-reflector 780 to form red+green output beam 758. In some embodiments, laser-combiner assembly 702 uses light from two RRGB laser arrays 301A and 301B that are combined together, producing one output beam having four parallel-column portions 755, 756, 757, and 758. The two RRGB laser arrays 301A and 301B are placed on opposite sides of the wavelength-selective filters, 180 degrees from one another and facing one another, in which two of the filter-reflectors (the upper-left filter-reflector 777 and lower-right filter-reflector 780 portions) transmit red and reflect blue and green, and the other two of the filter-reflectors (the upper-right filter-reflector 779 and lower-left 778 portions) reflect red and transmit blue and green. As shown in FIG. 7B, the red outputs of RRGB laser array 301A combine with the blue and green of RRGB laser array 301B and the red outputs of RRGB laser array 301B combine with the blue and green of RRGB laser array 301A. Together, both arrays, each with four columns, when combined, produce an output with a width of four columns, reducing the cross-section area of the combined output.

FIG. 7C is a block diagram cross-section view of a laser-combiner assembly 703 having two laser assemblies 301A and 301B, two reflectors 791 and 798, and two wavelength-selective filter-reflector 795 and 796, according to some embodiments of the present invention. In some embodiments, reflector 791 is highly reflective to at least red wavelengths, reflector 798 is highly reflective to at least green and blue wavelengths, wavelength-selective filter-reflector 795 selectively transmits red wavelengths and selectively reflects blue and green wavelengths, and wavelength-selective filter-reflector 796 selectively reflects red wavelengths and selectively transmits blue and green wavelengths. In some embodiments, multi-color laser assembly 301A includes two red lasers 714 and 713 that emit red laser beams 744 and 743, respectively, and reflector 791 reflects red laser beams 744 and 743, filter-reflector 795 selectively transmits red laser beam 744 and selectively reflects blue laser beam 742 to form coaxial red+blue output beam 785, and filter-reflector 795 selectively transmits red laser beam 743 and selectively reflects green laser beam 741 to form coaxial red+green output beam 786. Reflector 798 reflects the blue laser beam 752 from blue laser 732, which then passes through filter-reflector 796 and is coaxially combined with the reflected red laser beam 754 to form red+blue output beam 787. Reflector 798 reflects the green laser beam 751 from green laser 731, which then passes through filter-reflector 796 and is coaxially combined with the reflected red laser beam 753 to form red+green output beam 788. In some embodiments, the two planar mirrors 791 and 798 are used together with two color-selective filters 795 and 796. In some embodiments, planar mirrors 791 and 798 are broadband reflectors such as aluminum or silver mirrors, which lowers the cost compared to color-selective filters (such as shown in FIG. 7B).

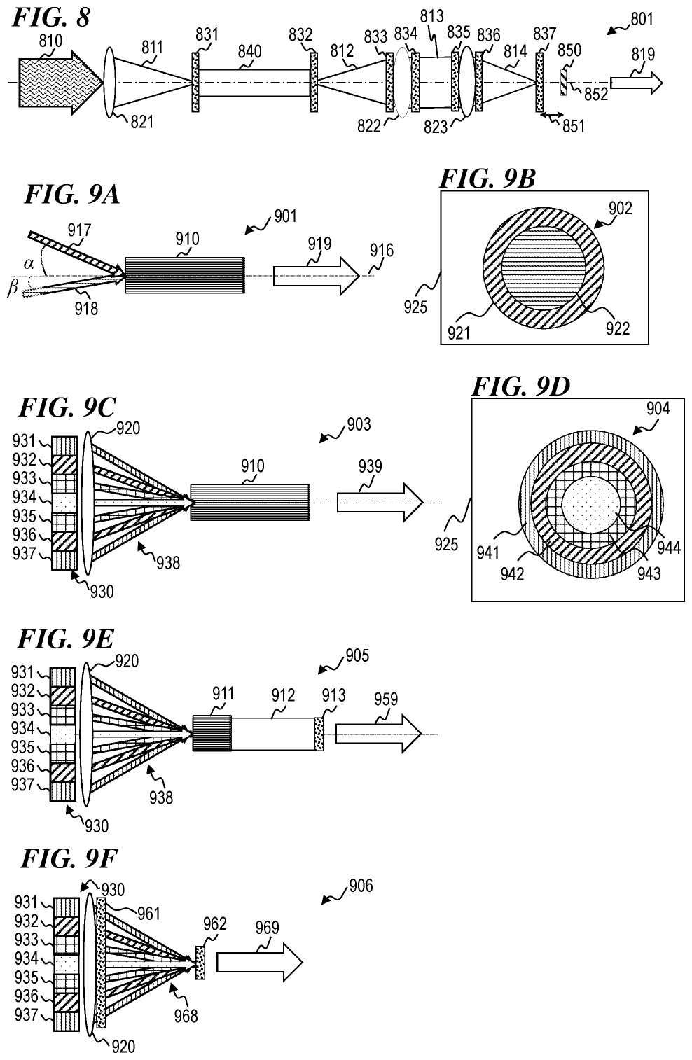

FIG. 7D is a block diagram cross-section view of a laser-combiner assembly 704 having two laser assemblies 301A and 301B, two reflectors 771 and 772 that are highly reflective to at least green and blue wavelengths, and two wavelength-selective filter-reflectors 773 and 774 (which each transmit green wavelengths and reflect blue wavelengths), and two wavelength-selective filter-reflectors 775 and 776 (which each transmits green and blue wavelengths and reflects red wavelengths), according to some embodiments of the present invention. In some embodiments, laser-combiner assembly 704 is another embodiment of an RGB light source where the left-hand column having two green lasers 711 and 731 emit two green laser beams reflected rightward and are each combined with one of the two blue laser beams from lasers 712 and 732 to form the center two green+blue beams, each of which is then combined using wavelength-selective filter-reflectors 775 and 776 (which each transmits green and blue wavelengths and reflects red wavelengths) with the reflected ones of the right-most red laser beams 744 and 754 from lasers 714 and 734 to form output red+green+blue (RGB) coaxial beams 782 and 783 in a coaxial fashion. The two red laser beams 743 and 753 are reflected as output red beam 781 above and output red beam 784 below the two red+green+blue coaxial beams 782 and 783 using the appropriate dichroic reflectors 775 and 776 as shown. As a result, in some embodiments, this provides the best three-wavelength mixing architecture of the system. The additional red column of lasers 713 and 733 emit laser beams 743 and 753, which are reflected by dichroic reflectors 775 and 776 to form output beams 781 and 784 propagating toward the output direction on the outer perimeters of the coaxially combined RGB (red+green+blue) output beams 782 and 783, since trying to combine red beams 784 and 784 with RGB beams 782 and 783 here (as compared to using combiners shown in FIG. 8, 9A, 9C, 9E, 9F, 10A-10F, or 14A-14F) would not mix well without introducing excessive losses. The red laser beams 744 and 754 from the right-hand column of red lasers 714 and 734 are sufficient for mixing purposes in order to produce various variable-color outputs (mixing selective amounts of each of red+green+blue), and in particular, producing a well-balanced white output when white is the desired output color. On the other hand, in some embodiments, the amount of red-laser power from each red-laser chip is lower than the power from each blue-laser chip or each green-laser chip. As a result, a high-brightness red beam typically requires a larger number of red laser diodes than the number of blue or green laser diodes. The extra column of red lasers 713 and 733 are used together with the right-hand red column of red lasers 714 and 734 for this purpose and the optical system at the output is designed based on this ability to use four input red laser beams 743, 744, and red-only portions of 753 and 754 together to provide intense red output when needed, along with two blue laser beams 742 and 752 and two green laser beams 741 and 751 when other colors are wanted.

FIG. 7E is a block diagram cross-section view of a laser-combiner assembly 705 having two laser assemblies 201R and 301BG, two reflectors 791 and 798, and two wavelength-selective filter-reflectors 776 and 797, according to some embodiments of the present invention. In some embodiments, red laser beams 761 and 762 are reflected by highly reflective reflector 791 and transmitted through wavelength-selective filter-reflector 797, which reflects upward propagating green laser beam 767 into combined coaxial red+green output beam 759. Wavelength-selective filter-reflector 797 reflects upward propagating blue laser beam 768 into coaxial combined red+blue output beam 749. In some embodiments, green laser beam 765 and blue laser beam 766 are reflected by highly reflective reflector 798 and transmitted through wavelength-selective filter-reflector 776, which reflects downward-propagating red laser beam 763 into coaxial combined red+blue output beam 769, and which reflects downward propagating red laser beam 764 into coaxial combined red+green output beam 799. In some embodiments, light from RRRR laser array 210R (having four red laser emitters) and GB GB laser array 301GB (having interspersed or alternating green-blue-green-blue laser emitters) are combined together producing one output beam having four parallel-column portions 749, 759, 769, and 799.

In other alternative embodiments (not shown), the RRRR and GB GB laser arrays are 180 degrees from one another and facing one another on opposite sides of the two wavelength-selective filters 776 and 797, but in these alternative embodiments, reflectors 791 and 798 are not used, and instead the wavelength-selective filter 797 extends from the lower left end of where 798 is shown in FIG. 7E to the upper right and is highly reflective of at least green on its portions reflecting light from the two green laser beams 765 and 767, and is highly reflective of at least blue on its portions reflecting light from the two blue laser beams 766 and 768. In some embodiments, this reflector is coated with a multi-layer dielectric reflection coating on its green-reflecting portions that is tuned to be particularly highly reflective to the laser light wavelength of the green laser beams 765 and 767, and is highly reflective of at least blue on its other portions (in some embodiments, portions of the wavelength-selective filter 797 replacement are coated with a multi-layer dielectric reflection coating to be particularly highly reflective to the laser light wavelength of the respective green or blue laser beams, so that the upper right portion of wavelength-selective filter 797 transmits red (beams 763 and 764 propagate to filter 776 and are reflected there) and reflects blue and green, and the lower-right filter portion of wavelength-selective filter 776 reflects red and transmits blue and green. In some of these alternative embodiments, reflector 791 is not used, and instead the wavelength-selective filter 776 extends from the lower right end of where 776 is shown in FIG. 7E to the upper left of where reflector 791 is shown and is highly reflective of the red outputs of RRRR laser array 201R, and transmissive to blue and green wavelengths to combine with the blue and green of GB GB laser array 301GB. Together, again, both arrays, each with four columns, when combined, produce an output (the same as 749, 759, 769 and 799 shown in FIG. 7E) with a width of four columns, reducing the cross-section area of the combined output.

FIG. 8 is a block diagram cross-section view of a laser-homogenizer assembly 801 having a light pipe 840, a plurality of lenses 821, 822, and 823, and one or more optional diffusers (e.g., one or more of 831, 832, 833, 834, 835, 836 and/or 837), according to some embodiments of the present invention. In some embodiments, an input light 810, which, in some embodiments, includes the output light (one or more laser beams or coaxial combined laser beams) from the devices of FIGS. 1, 2, 3, 4, 5, 6, 7A, 7B, 7C, 7D, and/or 7E, is focused by lens 821 to converging beam 811 into the left-hand end of light pipe 840 (through optional diffuser 831 if that is used), and the light propagates from the right-hand end of light pipe 840 as diverging beam 812 toward collimating lens 822 (through optional diffuser 832 if that is used and/or through optional diffuser 833 if that is used), and the resulting collimated beam 813 propagates (through optional diffuser 834 if that is used and/or through optional diffuser 835 if that is used) to focusing lens 823 and is focused by lens 823 to converging beam 814 into diffuser 837, which is separated by distance 851 from plate 850 and is output propagating along axis 852. Using laser-homogenizer assembly 801, the parallel output beams of the RGB laser array provide the parallel laser beams of input light 810 that are combined and homogenized into a single output beam 819 with uniform spatial and angular intensity profiles.

For the multi-laser-beam systems described above, in some embodiments, homogenization is desirable or required for both the spatial and angular domains such that the output is uniform at all viewing angles. Traditionally, spatial homogenization is done by using a light pipe with multiple reflections such that the output intensity profile will be the overlapped profiles of multiple input intensity profiles, providing an average that is more uniform than any individual intensity profile. The homogenization in the angular domain is usually done by using diffusers such that the angular non-uniformity is averaged out by the diverging property of the diffuser, but this method will have low efficiency due to loss of light in higher angles produced by the diffuser, which will not be collected. In some embodiments, the present invention provides homogenization of light in the angular domain using one or more fused-fiber bundles with tilted and non-tilted end faces. Depending on the spatial uniformity requirement, one or more additional light pipes are added, providing the spatial homogenizing function.

In some embodiments, to homogenize the output beams from one or more lasers singly or in a one-dimensional array, or a two-dimensional array, a fiber bundle is used, preferably a fused fiber bundle, as shown in FIG. 9A.

FIG. 9A is a block diagram cross-section view of a laser-combiner assembly 901 having two input laser beams 917 and 918 entering fused fiber bundle 910 at two different angles α and β, respectively, wherein output beam 919 has a larger spread angle for the light from laser beam 917 entering fused fiber bundle 910 from the larger angle α, and a smaller spread angle for the light from laser beam 918 entering fused fiber bundle 910 from the smaller angle β, according to some embodiments of the present invention. The light from each input beam 917 and 918 comes out of fused fiber bundle 910 centered along an optical axis 916 as a ring having a divergence angle substantially the same as the input beam angle and the thickness of the ring depends in part on the divergence of the input beam. In some embodiments, laser-combiner assembly 901 is used as an angular homogenizer, and a 4-by-6 array of lasers (such as shown in FIG. 1) generates twenty-four collimated input laser beams that are directed through a focusing lens into fused fiber bundle 910 such that the light from the twenty-four converging input laser beams comes out of the fused fiber bundle 910 as twenty-four diverging rings of light propagating along Z-axis directions, each with a certain thickness and divergence angle in the X and Y directions. In some embodiments, a single input beam incident into the fused fiber bundle will be transformed into a circular (conical) beam with the same angle of divergence as the incidence angle. In some embodiments, the angular thickness of the circular beam is the same as the divergence of the input beam. In this example, a green beam 917 and a blue beam 918 are incident at the input face of the fused fiber bundle 910 at different angles and each beam produces an output circle at different angle, forming two circles as shown in FIG. 9B. Instead of two single beams, the two circular beams increase the angular extent of the output, providing a basic angular-homogenizing mechanism.

FIG. 9B is a front view of a laser-beam output pattern 902 resulting from output beam 919 of FIG. 9A being projected against a flat surface 925, according to some embodiments of the present invention. In some embodiments, the outer ring-shaped portion 921 of output pattern 902 is primarily composed of light from laser beam 917, and the inner portion 922 of output pattern 902 is primarily composed of light from laser beam 918.

FIG. 9C is a block diagram cross-section view of a laser-combiner assembly 903 having a plurality of input laser beams 931-937 (in this example case, seven beams that have a plurality of different colors) focused and entering fused fiber bundle 910 at a plurality of different angles (in this example case, seven angles), wherein output beam 939 has a larger spread angle for the laser beam(s) entering fused fiber bundle 910 from a larger angle, according to some embodiments of the present invention. For example, in some embodiments, an array of lasers 930 include lasers 931 and 937 that each emit red collimated laser beams that are focused toward fused fiber bundle 910 at the largest convergence angles, lasers 932 and 936 that each emit green collimated laser beams that are focused toward fused fiber bundle 910 at the next-largest convergence angles, lasers 933 and 935 that each emit yellow collimated laser beams that are focused toward fused fiber bundle 910 at the next-to-smallest convergence angles, and laser 934 that emits (or, in other embodiments, a system of lasers such as shown in FIG. 7D that output a combined coaxial beam of laser colors (e.g., RGB)) a white collimated laser beam that is focused toward fused fiber bundle 910 at zero degrees or the smallest convergence angles. In some embodiments, laser-combiner assembly 903 forms an angular homogenizer and the output light 939 thus includes diverging rings of different colors of light propagating centered along Z-axis directions, each with a certain thickness and divergence angle in the X and Y directions. In other embodiments, lasers that emit different colors or that are arranged in different orders or two-dimensional array patterns are used to generate the converging beams 938.

FIG. 9D is a front view of a laser-light output pattern 904 resulting from output beam 939 of FIG. 9C being projected against a flat surface 925, according to some embodiments of the present invention. In some embodiments, the laser-light output pattern 904 includes an outer-most ring 941 that primarily includes red light from lasers 931 and 937, a next-to-outer-most ring 942 that primarily includes green light from lasers 932 and 936, a next-to-inner-most ring 943 that primarily includes yellow light from lasers 933 and 935, and a center portion 944 that primarily includes white light from laser 934. In other embodiments, lasers that emit different colors or that are arranged in different orders or array patterns are used to generate the converging beams 938, and thus the laser-light output pattern 904 would change in a corresponding manner. In some embodiments, all laser beams have the same color forming the rings as shown in FIG. 9D. When each of the laser beam has a large enough divergence, the overlapping ring pattern as shown in FIG. 9D will have a uniform intensity profile. In some embodiments, laser-combiner assembly 903 of FIG. 9C uses a one-dimensional array of seven collimated laser beams 938 focused at the input face of the fused fiber bundle 910. When fiber bundle 910 is placed at the center of the array, the beams from lasers 931 and 937 have the same incidence angle and together produce a single output beam circle 941. Similarly, the beams from lasers 932 and 936 have the same incidence angle and together produce a single output beam circle 942, and the beams from lasers 933 and 935 have the same incidence angle and together produce a single output beam circle 943. The final output 904 will have a center-filled circle 944 and three separate concentric rings of light. Depending on the divergence of the input laser beams, which determines the angular thickness of each beam circle, there will be an intensity variation along the radial direction. The more lasers that are used, the smaller will be the speckle variations. For example, when four rows of seven lasers are used in a two-dimensional input laser array, there will be a total of twenty-eight lasers forming approximately fourteen beam circles, slightly offset from each other, lowering the variation of the radial-intensity profile. In addition, the input face, the output face, or both can be angle-polished (i.e., at an angle non-perpendicular to the long axis) such that the beams will be tilted slightly when entering or exiting the fused fiber bundle. Such tilting changes the radii of the circles, the number of circles, the ellipticity of the circles, and the thickness of the circles, which enhances the uniformity of the output angular profile, providing a more homogenized angular intensity profile.

FIG. 9E is a block diagram cross-section view of a laser-combiner assembly 905 having a plurality of input laser beams 931-937 (in this example cross-section case, seven beams) focused by lens 920 and entering fused fiber bundle 911 at a plurality of different angles, wherein the output light of fused fiber bundle 911 is directed through light pipe 912 and then diffuser 913 to form output beam 959, according to some embodiments of the present invention. In some embodiments, the array of lasers 930, focusing lens 920, converging laser beams 938 are as described for FIG. 9C, and fused fiber bundle 911 is similar in function to fused fiber bundle 910 of FIG. 9C, and thus form an angular homogenizer for the input laser beams 938. Light pipe 912 (in some embodiments, having a hexagonal cross section shape) and diffuser 913 then form a spatial homogenizer for the light from fused fiber bundle 911, and the output light 959 is thus homogenized angularly and spatially. In some embodiments, the collimated laser beams from lasers 931-937 are all focused at the focal plane of the focusing lens 920. The focal spot is an overlapping of the focal spots of the individual lasers, which would not be uniform in intensity profile. Due to the tolerance of the alignment, the overlapping will not be perfect, resulting in bright spots in the spatial profile. The diffuser 913 spreads each bright spot into a small bright area, such that when a sufficient number of bright areas overlap each other, the intensity spatial profile at the focal plane will be sufficiently uniform. Although each beam is diffused to have a larger divergence angle by diffuser 913, the angular region between the beams may still be large enough such that the diffused beams from diffuser 913 may not suffice to spread and/or overlap the bright areas. To provide angular uniformity, a diffuser such as diffuser 962 (as shown in FIG. 9F) is placed at the focal plane of lens 920 of some embodiments to preserve or improve the spatial-intensity profile, but this spreads the angular intensity such that each beam will have a larger divergence emerging from the same focal spot on diffuser 962, such that all angular spaces are covered providing a more-uniform angular-intensity profile in output beam 959 in FIG. 9E, or output beam 969 of FIG. 9F.

FIG. 9F is a block diagram cross-section view of a laser-combiner assembly 906 having a plurality of input laser beams 931-937 (in this example case, seven beams) focused by lens 920 through first diffuser 961 and then entering directly second diffuser 962, which forms output beam 969, according to some embodiments of the present invention. In some embodiments, the array of lasers 930, focusing lens 920, are as described for FIG. 9C, and in this case, converging laser beams 968 are first diffused by diffuser 961 and again diffused by diffuser 962 and thus homogenized spatially and angularly in output light 969. In some embodiments, laser-combiner assembly 906 provides angle and spatial homogenization, allowing the output beam 969 to be focused into application optics to obtain the smallest angle, area and etendue for a collimated beam for such uses as stage lighting for concerts, and is better than filtered white light. In some embodiments, up to tens or hundreds of lasers are used for narrower beams, a vast variety of purer colors, homogenized in space and angle, and rather than having many small unmixed colored beams, the intense colors of the present invention are combined as a single beam having well-mixed colors across the entire beam which can have a variable divergence from a narrow to a wide beam by changing focus. In some embodiments, laser-combiner assembly 906 can use the combination of features of laser-combiner assembly 903 described above and laser-combiner assembly 909 described below.

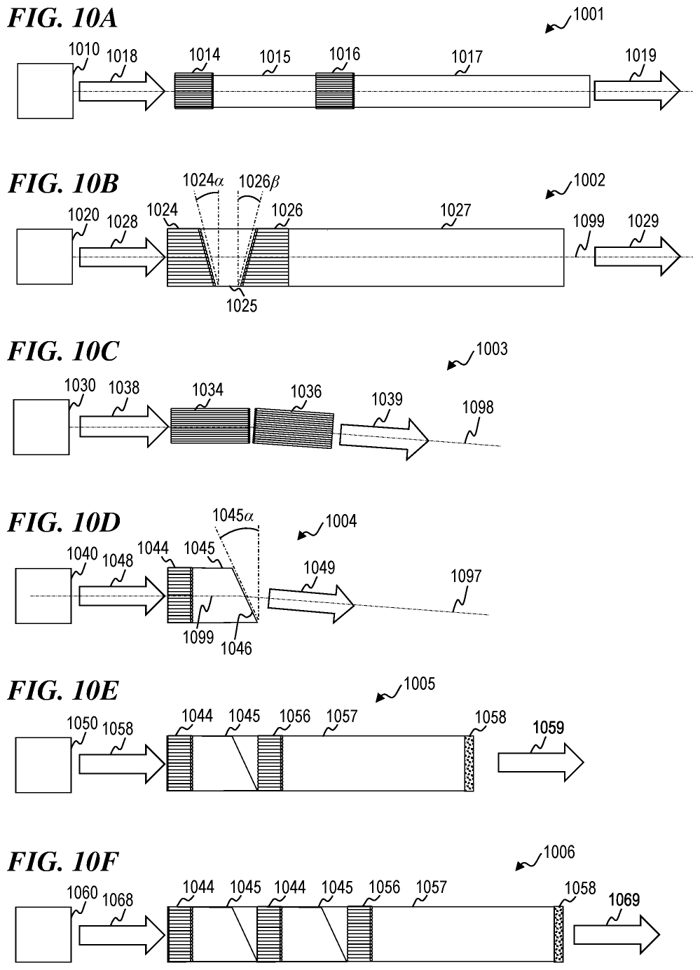

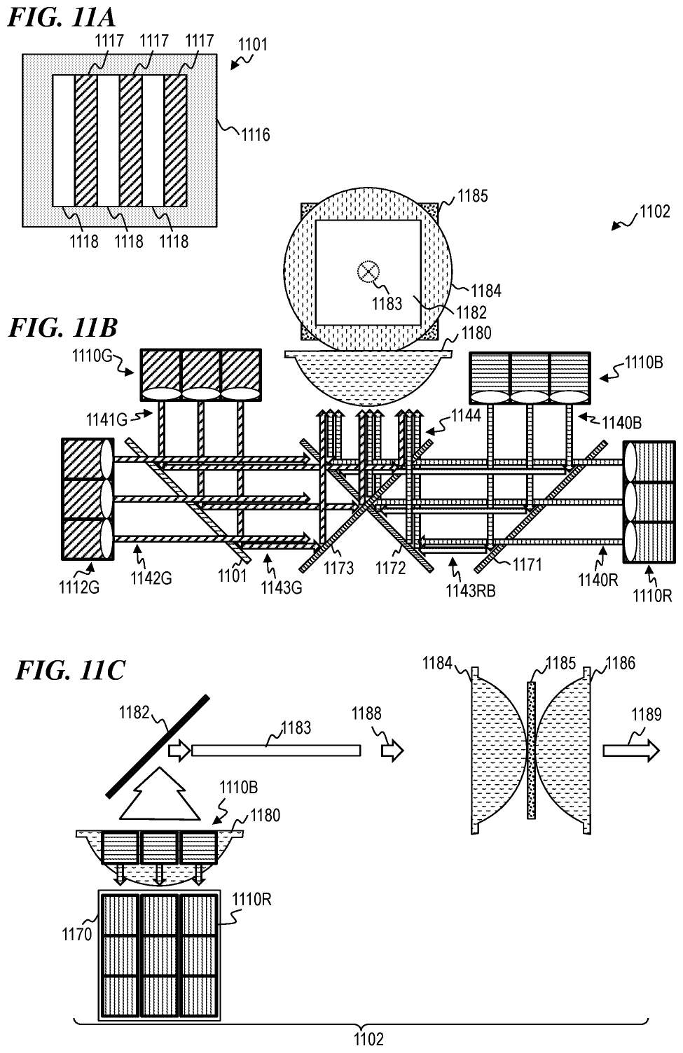

FIG. 10A is a block diagram cross-section view of a laser-combiner assembly 1001 having two fused fiber bundles 1014 and 1016 spaced apart by light pipe 1015, and directing light output of fused fiber bundle 1016 through light pipe 1017 to form output beam 1019, according to some embodiments of the present invention. In some embodiments, laser-combiner assembly 1001 includes a laser array 1010 that optionally includes a focusing lens to generate input laser light 1018, which, in some embodiments, is a converging array of laser beams that converge at a plurality of different angles to enter a first fused fiber bundle 1014. The angularly homogenized output light from the first fused fiber bundle 1014 is directed by first light pipe 1015 into a second fused fiber bundle 1016 that further angularly homogenizes the light and its output light is directed through second light pipe 1017 to form output light 1019. In some embodiments, the cross-sectional shape of either or both light pipe 1015 and light pipe 1017 are hexagonal (preferred for some embodiments), or circular or other suitable shape. Laser-combiner assembly 1001 allows a cascaded homogenization process providing further uniformity in both the spatial and angular domains. In some embodiments, if input beam 1018 is incident at an angle to the fused fiber bundle 1014, the input and output spatial profile will be a single point, as the fiber bundle would not change the spatial profile. The output angular profile from fiber bundle 1014 will be a circle. When this output is incident onto the second fused fiber bundle 1016, the input spatial profile will be a circle, which would produce the same output circular spatial profile. Each point of this circular spatial profile will also produce a circular angular profile. In other embodiments, if the input and/or output facets of the fused fiber bundles 1014 and 1016 are angled, the output from the first fused fiber bundle 1014 will produce an ellipse on the input face of the second fused fiber bundle 1016, and the angle of incidence will also be spread out by the tilting angle, which would provide further homogenization in the angular domain. FIG. 10B shows an example of such a system. In other embodiments, the tilting of the end faces are at the input, output, or both of each fused fiber bundle. The tilting of the angles can also be at different planes producing further spreading of angle.

FIG. 10B is a block diagram cross-section view of a laser-combiner assembly 1002 having two fused fiber bundles 1024 and 1026 each having sloped (angled) interface surfaces and spaced apart by light pipe 1025, and directing their light output through light pipe 1027 to form output beam 1029, according to some embodiments of the present invention. In some embodiments, laser-combiner assembly 1002 includes a laser array 1020 that optionally includes a focusing lens to generate input laser light 1028, which, in some embodiments, is a converging array of laser beams that converge at a plurality of different angles to enter a first fused fiber bundle 1024 that has a sloped output face at an angle 1024a to a surface perpendicular to the general propagation axis 1099. The angularly homogenized output light from the first fused fiber bundle 1024 is directed by first light pipe 1025 into a second fused fiber bundle 1026 that has a sloped input face at an angle 10260 to a surface perpendicular to the general propagation axis 1099. Second fused fiber bundle 1026 further angularly homogenizes the light and its output light is directed through second light pipe 1027 to form output light 1029. In some embodiments, angle 10260 is complementary (at an opposite angle) relative to angle 1024a in order to restore the general light propagation direction to be along general propagation axis 1099.

FIG. 10C is a block diagram cross-section view of a laser-combiner assembly 1003 having two fused fiber bundles 1034 and 1036 each having interface surfaces that are perpendicular to their respective central axes, according to some embodiments of the present invention. In some embodiments, fused fiber bundles 1034 and 1036 are arranged at an angle to one another to form output beam 1039 along output axis 1098. In some embodiments, fused fiber bundles 1034 and 1036, each having interface surfaces that are perpendicular to their respective central axes, are less costly to fabricate than fused fiber bundles 1024 and 1026 of FIG. 10B, which have sloped interface surfaces. In some embodiments, laser-combiner assembly 1003 includes a laser array 1030 that optionally includes a focusing lens to generate input laser light 1038, which, in some embodiments, is a converging array of laser beams that converge at a plurality of different angles to enter a first fused fiber bundle 1034. In some embodiments, two fused fiber bundles 1034 and 1036, each with perpendicular input and output faces to reduce cost as compared to polishing faces at non-perpendicular angles as in Figure are configured at an angle to each other. The output of the fiber bundle 1034 is incident into the fiber bundle 1036 which is oriented at an angle, increasing the angular uniformity of output beam 1039.

FIG. 10D is a block diagram cross-section view of a laser-combiner assembly 1004 having one fused fiber bundle 1044 having perpendicular interface surfaces and a light pipe 1045 having an output face 1046 at a non-perpendicular angle 1045a to a surface perpendicular to central axis 1099 of the light from fused fiber bundle 1044 to form angled output beam 1049 having an axis of propagation 1097, according to some embodiments of the present invention. In some embodiments, laser-combiner assembly 1004 includes a laser array 1040 that optionally includes a focusing lens to generate input laser light 1048, which, in some embodiments, is a converging array of laser beams that converge at a plurality of different angles in input light 1048 to enter fused fiber bundle 1044. In some embodiments, this combination of fused fiber bundle 1044 and angled-output-face light pipe 1045 is used as a unit cell in which a plurality of these cells are used, providing the needed uniformity in both the spatial and angular domains.

FIG. 10E is a block diagram cross-section view of a laser-combiner assembly 1005 having a first fused fiber bundle 1044 having perpendicular interface surfaces and light pipe 1045 having its output face at a non-perpendicular angle to the central axis of light from fused fiber bundle 1044 such as shown in FIG. 10D. Light pipe 1045 has its output light coupled through a second fiber bundle 1056, light pipe 1057 and diffuser 1058 to form output beam 1059, according to some embodiments of the present invention. In some embodiments, light pipe 1057 provides additional mixing function.

FIG. 10F is a block diagram cross-section view of a laser-combiner assembly 1006 having two unit cells of fused fiber bundle 1044 and light pipe 1045, each having its output face at a non-perpendicular angle to the light from fused fiber bundle 1044, which are sequentially positioned to have their output coupled through fused fiber bundle 1056, light pipe 1057 and diffuser 1058 to form output beam 1069, according to some embodiments of the present invention. In some embodiments, a plurality of the components described above are used serially to further homogenize the output beam angularly and spatially for excellent color purity for a wide range of mixed colors while the output beam maintains good etendue, and that output beam can be manipulated by projection optics to be a narrow, collimated beam or adjusted for various output-spread angles.

FIG. 11A is a block diagram plan view of a striped reflector 1101 having a plurality of reflective stripes 1117 alternating with a plurality of transparent stripes 1118 held in a frame 1116, according to some embodiments of the present invention. In some embodiments, striped reflector 1101 includes a plurality of reflecting stripes 1117 that each reflect light (e.g., in some embodiments, green laser beams 1141G of FIG. 11B) from one row of lasers in a first laser array (e.g., laser array 1110G of FIG. 11B), wherein each reflecting stripe is separated from neighboring reflecting stripe by open or transparent stripes that pass light (e.g., in some embodiments, green laser beams 1142G of FIG. 11B) from a second laser array (e.g., laser array 1112G of FIG. 11B), according to some embodiments of the present invention. In some embodiments, the reflective surface of each reflective stripe 1117 is broadband, with little or no wavelength selection. On the other hand, in other embodiments, a green dichroic coating (such as a multi-layer dielectric coating having a plurality of alternating layers of different indices of refraction with thicknesses selected to better reflect green light) is used to provide higher reflectivity.

FIG. 11B is a block diagram cross-section elevation view, from a first viewing direction, of a laser-combiner assembly 1102 having two banks of similarly or identically colored lasers 1110G and 1112G directed at striped reflector 1101, and two banks of different-colored lasers 1110B and 1110R directed at a wavelength-selective reflector-filter reflector 1171, according to some embodiments of the present invention. In some embodiments, each bank of lasers includes a plurality of lasers arranged in an array of one or more rows (one row of each bank is shown here), each having a plurality of columns of lasers (three lasers in each bank are shown here) emitting the same color of laser light. In some embodiments, laser bank 1112G emits three green laser beams 1142G that pass through the transparent stripes 1118 of striped reflector 1101, and laser bank 1110G emits three green laser beams 1141G that reflect from the reflective stripes 1117 of striped reflector 1101 (the three reflected beams as shown here in combined beams 1143G, for clarity of presentation, as being below the three transmitted beams 1142G, but are in some embodiments, behind beams 1142G relative to the view here), and the resulting six green laser beams 1143G are reflected by wavelength-selective filter-reflector 1173 upward as the green portions of beams 1144 into condensing lens 1180. In some embodiments, wavelength-selective filter-reflector 1173 is transmissive to red and blue wavelengths of beams 1143RB and reflective to green wavelengths of beams 1143G. In some embodiments, the three laser beams 1140R (in some embodiments, red laser beams) from laser bank 1110R are transmitted through wavelength-selective filter-reflector 1171, while the three laser beams 1140B (in some embodiments, blue laser beams) from laser bank 1110B are reflected by wavelength-selective filter-reflector 1171 to be combined and coaxial with the transmitted laser beams 1140R in combined beams 1143RB. The resulting three coaxial red+blue beams 1143RB are reflected upward by wavelength-selective filter-reflector 1172 (which, in some embodiments, is reflective of red and blue wavelengths and transmissive to green wavelengths). The upward-propagating focused output light from condenser lens 1180 is reflected by forty-five-degree mirror 1182 (toward a propagation axis direction into the paper here toward light guide 1183) and toward collimating lens(es) 1184 to form an output beam 1189 (see FIG. 11C). In other embodiments, laser arrays of different numbers of lasers of each color are used, or the arrays of lasers supplying laser beams to slotted reflector 1101 each have red or blue colors, and an array of green lasers replaces one of the arrays of lasers supplying laser beams to wavelength-selective filter-reflector 1171 and wavelength-selective filter-reflector 1171 is changed suitably for the desired wavelengths to be transmitted and those to be reflected. In some embodiments, the combined beam output 1143G from slotted reflector 1101 of laser light from the two green-laser arrays 1110G and 1112G is an array of 3×6 laser beams, approximately doubling the output intensity as compared to a single 3×3 array in approximately the same cross-sectional area. In some embodiments, (not shown in the figures), another set of two laser arrays and another slotted reflector can be added to the system, with a 3×6 laser array placed orthogonal to the first set (producing a 6×3 beam output). Both sets of output will then be combined using a third slotted (e.g., checkerboard pattern) reflector such that the 3×6 and 6×3 output from the first two sets will be combined into a single output of 6×6 output, with all the spaces filled up. This increases the output of the green lasers approximately four times with four laser arrays with similar cross-sectional areas, further increasing the brightness of the system.

In some embodiments, laser-combiner assembly 1102 uses laser array 1110R having a plurality of red-color lasers, laser arrays 1110G and 1112G each having a plurality of green-color lasers, and laser array 1110B having a plurality of blue-color lasers in order that the inherent randomness between the lasers of each color reduces speckle contrast, according to some embodiments of the present invention. In some embodiments, to provide a balanced white output, two green laser arrays 1110G and 1112G are used. Each laser array in this embodiment is made up of a 3×3 array arrangement of lasers. In some embodiments, each laser of each 3×3 laser array is packaged into a TO-9 package with a collimating lens mounted in front of the laser as part of the TO-9 package. Each respective composite output laser beam array 1141G, 1142G, 1140R and 1140B is a collimated composite beam with nine parallel beams emitted from the respective 3×3 laser array 1110G, 1112G, 1110R and 1110B. In some embodiments, each respective laser array 1110G, 1112G, 1110R and 1110B is backed with a finned heat sink (not shown). In some embodiments, due to the space required between each TO-9 package, there are spaces between the laser beams, which are, in some embodiments, filled with another set of parallel laser beams using a slotted light reflector 1101 as shown in FIG. 11A, with details of the slotted reflector as described in the description FIG. 11A.

In some embodiments of laser-combiner assembly 1102, the required amounts of red and blue light are less than the required amount of green light, and as a result, one array 1110R of red lasers and one array 1110B of blue lasers are used, while two arrays 1110G and 1112G of green light are used. In some embodiments, the output from the red laser array 1110R and blue laser array 1110B are combined using a slotted reflector 1101, or simply using a red-pass, blue-reflect filter, which reflects blue and passes red to form red-blue beam array 1143RB. The red-blue beams 1143RB and the green beams 1143G are then combined using an X-mirror made up of wavelength-selective reflector 1172 that passes green and reflects red and blue and wavelength-selective filter 1173 that reflects green and passes red and blue such that composite collimated beams 1144 having all the red, green, and blue color laser beams are directed and focused through lens 1180, reflected by reflector 1182 into light guide (or light pipe) 1183, wherein the light 1188 (see FIG. 11C) from light guide 1183 is towards the output direction towards and through focusing lens 1184, diffuser 1185, and focusing lens 1186 as shown in FIG. 11C. FIG. 11B is an elevation view from a first direction of light source 1102, according to some embodiments of the present invention.

FIG. 11C is an elevation view from a second viewing direction (perpendicular to the first viewing direction of FIG. 11B) of light source 1102, according to some embodiments of the present invention. FIG. 11C shows the light from the focusing lens 1180 is turned 90 degrees from the vertical to the horizontal directions towards hexagonal light guide 1183 that is horizontal in this view. In some embodiments, hexagonal light guide 1183 has six flat surfaces that provide multiple internal reflections of the laser beams, which homogenizes the intensity profile, providing a uniform mixed-color intensity in beam 1188 at the output of the light guide. In other embodiments, the hexagonal light guide 1183 is replaced by a multi-sided light guide having a different number of sides (e.g., 5, 7, 8, 9 or more sides). In some embodiments, hexagonal light guide 1183 is used when the needs of the output application are for output beam 1189 to have a round cross section. In some embodiments, when an output application has a need for a rectangular beam, a rectangular light guide is used for light guide 1183. In addition, in some embodiments, a tapered light guide, in which the input and output cross-sectional dimensions are different, is used for applications needing the transformation of cross-sectional shapes, areas and/or angles of the input beam relative to the output beam.

Similar to the four-array, mostly green-laser system (called mostly green since a larger number of green lasers are used as compared to the numbers of red or blue lasers) described previously, other embodiments use one or more additional slotted reflectors 1101, wherein the additional slotted reflector(s) 1101 combine the light from additional red and/or blue laser arrays, when higher red and blue output light intensities are required, such that two or more red laser arrays and two or more blue laser arrays are used, using a combination of slotted (or checkerboard pattern) reflectors 1102 and/or wavelength-selective (dichroic) reflectors/filters.

In the described embodiment of laser-combiner assembly 1102 shown in FIG. 11B and FIG. 11C, 3×3 arrays of lasers are used. For other embodiments that may need different output aspect ratios or light power, other arrays sizes can be used, such as 2×2, 4×4, 2×4, 4×3, etc. In some embodiments, in each laser array, the laser diodes all have the same color, while in other embodiments, each array includes a combination of lasers that emit different colors. Instead of the standard three colors of red, green, and blue (RGB), other embodiments use different wavelengths or colors of laser diodes and/or phosphors and/or wavelength-converting nonlinear crystal lasers and/or other lasers. In those cases, the colors reflected or passed by the wavelength-selective reflector filter(s) are adjusted based on the colors used in order to combine them into a single output beam.

In some embodiments, based on the number of lasers used, the speckle contrast of the output decreases (i.e., improves to a more desirable or pleasing light output) as the number of lasers of each given color increases. If a still-lower speckle contrast is required, in some embodiments, one or more of the diffusers used are driven by actuators that provide rotational and/or translational movements at a frequency higher than the human-eye-flicker response (e.g., in some embodiments, higher than 30 hertz), such that when the laser beams pass through the moving diffuser, the speckle contrast is further reduced. The rotational or translational speed and the diffusive properties of the diffuser will determine the final speckle contrast.

In some embodiments, a simple reflective rod system is used to reflect laser beams into a smaller cross-sectional area, in which the outputs of the TO-packages from a laser array package are coupled into a single output beam effectively and with smaller etendue for efficient coupling. Such reflective rods can be made with opaque solids with a reflective surface, or with transparent material using total internal reflection (TIR). Each rod can be used to reflect output from one or more lasers such that an array of laser diodes uses an array of such rods to combine the outputs and direct them in the same output direction. The rods are made such that their dimensions match with the spacing of the laser diodes and the spacing of the laser beams. To combine the laser outputs, multiple rods are mechanically packed together, forming a system with multiple reflective surfaces, reflecting the laser outputs toward the output direction. Such a system is very flexible and able to adapt to various laser-diode configurations.

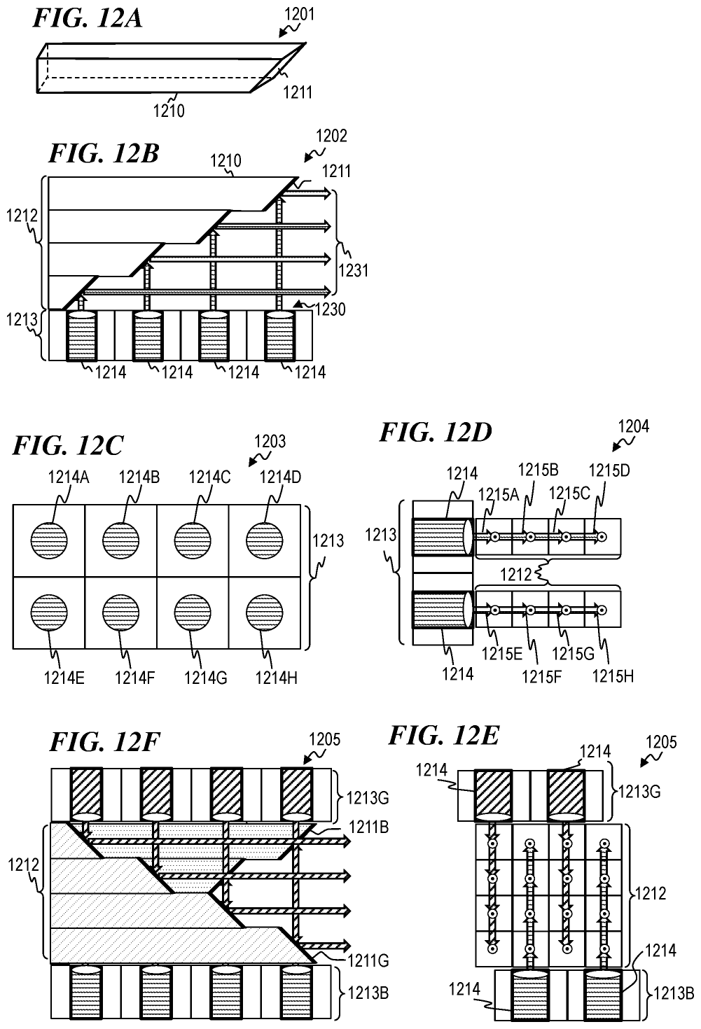

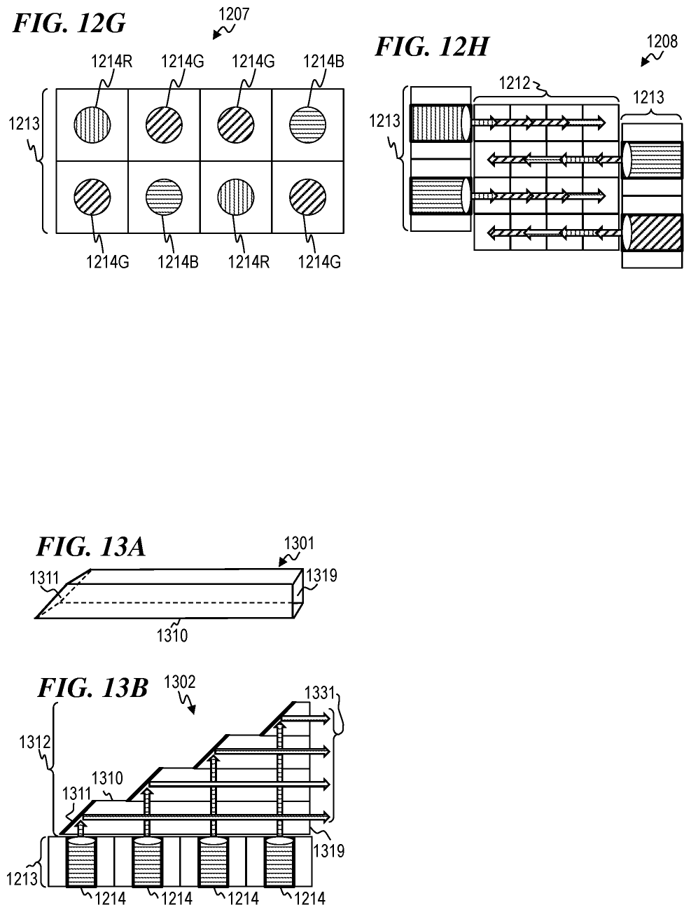

FIG. 12A is a block diagram perspective view of an angled reflector 1201 made from a rectangular rod 1210 (e.g., in some embodiments, a square metal rod, while in other embodiments, rod 1210 is made of polymer, glass, ceramic or other suitable material, and/or has some other suitable cross-sectional shape) having a highly reflective angled-end surface 1211, according to some embodiments of the present invention.

FIG. 12B is a block diagram cross-section view of a laser-beam combiner assembly 1202 having a laser bank 1213 that includes a plurality of, e.g., four, lasers 1214 directed at a stepped angle reflector 1212, according to some embodiments of the present invention. In some embodiments, stepped reflector assembly 1212 is made from a plurality of angled reflectors similar to angled reflector 1201, each having a cross sectional height corresponding to a width of one of the plurality of laser beams 1230 emitted from the plurality of lasers 1214 in laser array 1213 (or, in some other embodiments, a width of a majority of each beam if it is satisfactory to reflect just that much of each beam). Thus, while the center-to-center spacing of lasers is constrained by packaging and/or heat-dissipation considerations for lasers 1214, the center-to-center spacing of laser beams 1231 is closer in order to maintain good etendue in the output light 1231 as it is further processed, mixed and projected. In some embodiments, the input beams 1230 are elliptical and the output beams 1231 are made even narrower (closer together) by matching the width and spacing of each mirror 1211 to the width of the elliptical beam in its narrow direction. As a result, the four laser beams 1231 propagating in the horizontal direction in FIG. 12B have a beam-to-beam spacing determined by the spacing of the laser diodes 1214 of laser array 1213 combined as shown to four-beam output 1231 with a smaller beam-to-beam spacing determined by the spacing of the stepped mirrors and the narrow beam width of each beam with the total output cross-section dimensions smaller than the original beams in the original vertical direction.

FIG. 12C is a block diagram plan view of an arrayed laser bank 1203 having a plurality of columns and a plurality of rows of lasers 1214 in a laser bank 1213 that each output similarly-colored laser beams, according to some embodiments of the present invention. In some embodiments, laser array 1213 has two rows of four columns each of the eight lasers 1214A through 1214H. In some embodiments, each laser of laser array 1213 outputs a respective collimated blue laser beam 1215A through 1215H (see FIG. 12D). In other embodiments, the color of the output laser beams is green, red, or other suitable color.

FIG. 12D is a block diagram end view, partially in cross-section, of a laser-beam combiner assembly 1204 having a laser bank 1213 that includes a plurality of, e.g., eight, lasers 1214 directed at two stepped angle reflectors 1212, according to some embodiments of the present invention. In some embodiments, the upper four lasers 1214 (only one of which is shown in cross section here) emit collimated laser beams 1215A through 1215D that are reflected toward the viewer by the upper stepped reflector 1212 as four closely spaced parallel beams, and the lower four lasers 1214 (only one of which is shown in cross section here) emit collimated laser beams 1215E through 1215H that are reflected toward the viewer by the lower stepped reflector 1212 as four closely spaced parallel beams. In some embodiments, using three commercially available laser banks, each with a 2×4 laser array using eight lasers, having their output laser beams 1215A-1215H with spacings narrowed using stepped mirrors 1212 as shown here, the output laser beams (reflected toward the viewer from the drawing paper) are then combined with beams of other colors using wavelength-selective filter-reflectors such as shown in FIG. 6. In some embodiments, higher power is obtained using more units of these laser banks with more lasers.

FIG. 12E is a block diagram end view, partially in cross-section, of a laser-beam combiner assembly 1205 having two laser banks 1213B and 1213G that each includes a plurality of, e.g., eight, lasers 1214, each directed from opposite directions at two stepped angle reflectors 1212, according to some embodiments of the present invention. In some embodiments, laser bank 1213B includes eight blue-emitting lasers 1214 that emit their respective blue laser beams upward and their respective stepped reflectors 1212 in the second and fourth columns reflect the respective beams perpendicularly out of the paper toward the viewer, and laser bank 1213G includes eight green-emitting lasers 1214 that emit their respective green laser beams downward and their respective stepped reflectors 1212 in the first and third columns reflect the respective beams perpendicularly out of the paper, also toward the viewer. The overall output beam has both green and blue laser beams combined in the same cross-sectional dimension of the individual beams. This allows the preservation of the etendue of each laser bank.

FIG. 12F is a block diagram side view (perpendicular to the view of FIG. 12E), partially in cross-section, of laser-beam combiner assembly 1205 having two laser banks 1213B and 1213G that each includes a plurality of, e.g., eight, lasers 1214, each directed at two stepped angle reflectors 1212, according to some embodiments of the present invention. From this view, the four green laser beams are shown, and the four blue laser beams are behind the four green laser beams.

FIG. 12G is a block diagram plan view of an arrayed laser bank 1207 having a plurality of columns and a plurality of rows of lasers 1213 that output different-colored laser beams, according to some embodiments of the present invention. In some embodiments, arrayed laser bank 1207 includes a plurality of lasers 1213 that includes two red lasers 1214R that emit red laser beams, two blue lasers 1214B that emit blue laser beams and four green lasers 1214G that emit green laser beams.

FIG. 12H is a block diagram end view, partially in cross-section, of a laser-beam combiner assembly 1208 having two laser banks 1213 that each includes a plurality of, e.g., eight, lasers 1214 that output different-colored laser beams directed at two stepped angle reflectors 1212, according to some embodiments of the present invention. The two laser banks 1213 direct their respective eight laser beams each from the left and right to the two stepped angle reflectors 1212, which then reflect the sixteen beams toward the viewer from the drawing paper in a closely spaced four-by-four array of parallel beams of the various input colors.

FIG. 13A is a block diagram perspective view of an angled transparent reflector 1301 made from a rectangular transparent rod 1310 (e.g., of a transparent polymer, glass or crystal) having a highly reflective angled-end surface 1311, according to some embodiments of the present invention. In some embodiments, the input laser beam enters through the bottom surface, is reflected internally by surface 1311, and exits through output facet 1319.

FIG. 13B is a block diagram cross-section view of a laser-beam combiner assembly 1302 having a laser bank 1213 that includes a plurality of, e.g., four, lasers 1214 directed at a stepped angle reflector 1312, according to some embodiments of the present invention. In some embodiments, stepped angle reflector 1312 includes four angled transparent reflectors 1310 of varied lengths and optionally fused into a single piece, while in other embodiments, a single molded, cut or carved piece of transparent polymer, glass or crystal having a plurality of stepped angled internal reflectors 1311 is used, wherein the plurality of output beams 1331 have a closer spacing than the spacings between the input beams from lasers 1214.

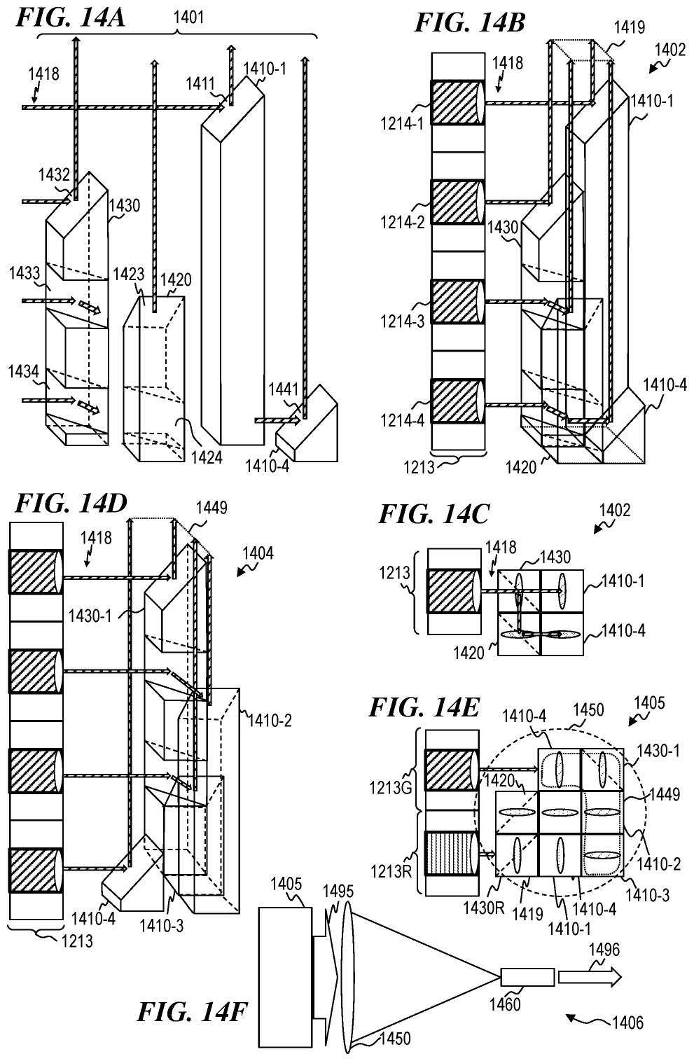

FIG. 14A is an exploded perspective view block diagram of a laser-beam reflector assembly 1401 having four end reflectors and optionally having side reflectors, according to some embodiments of the present invention. In some embodiments, laser-beam reflector assembly 1401 includes a first end-reflector rod 1410-1, an end-side-side reflector rod 1430, and end-side reflector rod 1420, and a second end-reflector rod 1410-4. End-reflector rod 1410-1 receives a level-1 (top-most) horizontal laser beam of laser beam group 1418 at its 45-degree end reflector that is reflected upward. End-side-side reflector rod 1430 receives a level-2 (next-to-top-most) horizontal laser beam of laser beam group 1418 at its 45-degree end reflector that is reflected upward, receives a level-3 (next-to-bottom-most) horizontal laser beam of laser beam group 1418 at its upper 45-degree side reflector that is reflected horizontally toward the top end reflective surface 1423 of rod 1420, and receives a level-4 (bottom-most) horizontal laser beam of laser beam group 1418 at its lower 45-degree side reflector that is reflected horizontally toward the side reflective surface 1424 of rod 1420. End-side reflector rod 1420 receives two horizontal beams reflected by the side reflective surfaces of rod 1430, and top reflective surface 1423 reflects the upper beam upward, and side reflective surface 1424 reflects the level-4 beam toward rod 1410-4, which reflects that beam upward. When the four rods 1410-1, 1430, 1420 and 1410-4 are closely packed as shown in FIG. 14B, the four-by-one vertically-spaced-apart input laser beams 1418 that start in a single plane are reflected to a two-by-two set of parallel output beams 1419.

FIG. 14B is a perspective view block diagram, partially in cross section, of a laser-beam reflector combiner assembly 1402 having four rods having end reflectors and optionally having side reflectors, and four input lasers 1214-1 through 1214-4 forming laser array 1213, according to some embodiments of the present invention. In some embodiments, the upper-most level-1 laser 1214-1 emits a horizontal beam that is reflected upward by the end-reflector rod 1410-1, the next-to-upper-most level-2 laser 1214-2 emits a horizontal beam that is reflected upward by the end reflector 1432 (see again FIG. 14A) of rod 1430, the next-to-lower-most level-3 laser 1214-3 emits a horizontal beam that is reflected perpendicularly horizontally toward rod 1420 and then upward by the end reflector 1423 of rod 1420, and the lower-most level-4 laser 1214-4 emits a horizontal beam that is reflected perpendicularly horizontally toward rod 1420, then reflected perpendicularly horizontally toward rod 1410-4 and then upward by the end reflector 1441 of rod 1410-4. In some embodiments, rod 1420 is implemented by two rod segments that are fabricated separately and then stacked, the lower rod segment that reflects an input horizontal beam toward a perpendicular horizontal direction, and the upper rod segment that reflects an input horizontal beam toward a vertical direction. In some embodiments, rod 1430 is implemented by three stacked rod segments, the lower two rod segments that reflects an input horizontal beam toward a perpendicular horizontal direction, and the upper rod segment that reflects an input horizontal beam toward a vertical direction.

FIG. 14C is a plan view block diagram, partially in cross section, of laser-beam reflector combiner assembly 1402 having four rods having end reflectors and optionally having side reflectors, and four input lasers of laser array 1213, according to some embodiments of the present invention. In some embodiments, the four input beams have a wider divergence angle in one direction than in its other perpendicular direction, so that the two output beams propagating in the direction toward the viewer are taller than wide from the end reflectors of rods 1430 and 1410-1, and the output beam propagating in the direction toward the viewer from the end reflectors of rod 1420 is wider than tall due to the horizontal reflection.

FIG. 14D is a perspective view block diagram of a laser-beam reflector assembly 1404 having four rods with end reflectors, one of which has two side reflectors, and four input lasers of laser array 1213, according to some embodiments of the present invention. In some embodiments, end-side-side reflector rod 1430-1 receives a level-1 (top-most) horizontal laser beam of laser beam group 1418 at its 45-degree end reflector that is reflected upward, receives a level-2 (next-to-top-most) horizontal laser beam of laser beam group 1418 at its upper 45-degree side reflector that is reflected horizontally toward the top end reflective surface rod 1410-2, and receives a level-3 (next-to-bottom-most) horizontal laser beam of laser beam group 1418 at its lower 45-degree side reflector that is reflected horizontally toward the end reflective surface of rod 1410-3. A level-4 (bottom-most) horizontal laser beam 1418 is reflected vertically by the end reflective surface of rod 1410-4. When the four rods 1430-1, 1410-2, 1410-3 and 1410-4 are closely packed as shown in FIG. 14D, the four-by-one vertically-spaced-apart input laser beams 1418 that start in a single plane are reflected to an L-shaped set of parallel output beams 1449.

FIG. 14E is a plan view block diagram, partially in cross section, of laser-beam reflector combiner assembly 1405 having eight end reflectors and optionally having side reflectors, and eight input lasers 1213G (e.g., in some embodiments, green lasers) and 1213R (e.g., in some embodiments, red lasers), according to some embodiments of the present invention. In some embodiments, reflector combiner assembly 1405 includes a combination of beam reflector assembly 1402 with its square two-by-two output beams 1419 and beam reflector assembly 1404 with its L-shaped set of parallel output beams 1449 wrapped around the sides of the two-by-two output beams 1419.

FIG. 14F is a side view block diagram, partially in cross section, of laser-beam combiner assembly 1406, according to some embodiments of the present invention. In some embodiments, the output 1495 from laser-beam reflector combiner assembly 1405 is focused by lens 1450 into the end of light-beam combiner or light pipe 1460 (e.g., in some embodiments, any of the beam combiners of FIGS. 9A, 9C, 9E, 9F, and/or 10A through 10F), which homogenizes the light and outputs beam 1496.

To further homogenize the combined RGB laser beams, in some embodiments, an optional diffuser is placed in front of the light pipe 1460 such that the angle of incidence can be increased, allowing more reflections inside the light pipe. The output 1496 will then have a more uniform intensity profile. Similarly, an optional diffuser can also be added to the output of the light pipe 1460, further homogenizing the output RGB beam. The output RGB beam 1496 will have an area which is the cross-section of the light pipe 1460 and a divergence angle determined by the input convergence angle from the focusing lens 1450 and the amount of diffusion angle introduced by the optional diffusers. More optional diffusers can be added on one side or both sides of the coupling lenses such that the combination of the diffusers will provide the needed intensity profile while optimizing the efficiency of the system.

In some embodiments, the output light is imaged onto a target using coupling lenses so that the area and the convergence angle can be achieved for the particular target for the highest coupling efficiency possible. To further achieve the desired intensity profile on the target, an optional diffuser can also be placed in front of the target with a small gap, as shown in FIG. 8. The gap can be adjusted to provide the most optimal dimensions and uniformity desired. The target could be a GOBO (goes before optics) device, a DMD (digital micromirror device) imager, an LCD (liquid-crystal display) imager, or the output could simply be a beam of light.

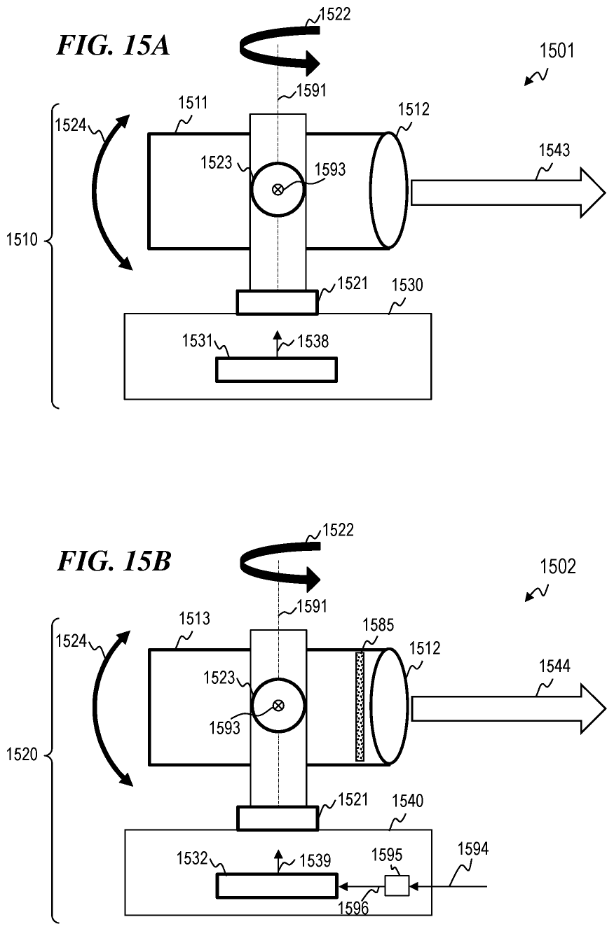

FIG. 15A is a side view block diagram of a moving head spot light 1501, according to some embodiments of the present invention. In some embodiments, moving head spot light 1501 includes an assembly 1510 having an RGB laser light source 1511 and its projection lens or optics 1512 that generates output beam 1543 that is pointed in different selected altitude angles and azimuth angles. In some embodiments, RGB laser assembly 1511 includes one or more of the systems of FIG. 1 through FIG. 14F or combinations thereof. In some embodiments, RGB laser light source 1511 and projection optics 1512 are rotated around horizontal axis 1593 by a rotary actuator 1523 to selected altitude angles 1524, and rotated around vertical axis 1591 by a rotary actuator 1521 to selected azimuth angles 1522, wherein both rotary actuator 1523 and rotary actuator 1521 are controlled by signals 1538 from controllers 1531 mounted in chassis 1530. In some embodiments, signals 1538 also control the hue, saturation, intensity and timing of the red, green and blue components of output beam 1542 by controlling current (in some embodiments, using pulse-width modulation) to the various red, green and blue lasers in assembly 1511. In some embodiments, projection optics 1512 include an actuator, also controlled by signal 1538, that changes a divergence angle of beam 1543 to be a very narrow beam or to have a variably wider divergence angle. In some embodiments, RGB laser light source 1511 and optics 1512 are used in a moving head system 1510 for stage lighting. The output from the light source 1511 is projected as output beam 1543 toward a target through projection lens 1512. In some embodiments, the color of the output beam 1543 is controlled by varying the currents to each color lasers. The beam divergence is controlled by signals 1538 controlling the projection lens 1512 and other appropriate lenses inside the system 1510. In some embodiments, various GOBO and beam-modification optics are included and controlled. All these functions are controlled by controller electronics system 1531. The direction of the beam is controlled by rotary motors or actuators 1521 and 1523 for rotation around both the horizontal axis 1593 and vertical axis 1591.

FIG. 15B is a side view block diagram of an ultra-long-range laser spotlight 1502 that includes red, green, blue and optionally infrared (IR) laser light, according to some embodiments of the present invention. In some embodiments, spotlight 1502 includes RGB+IR laser light source 1513 combined with the other items shown to function as a long-range spotlight system 1520. In some embodiments, RGB+IR laser light source 1513 includes those things in RGB laser light source 1511 of FIG. 15A, plus one or more IR lasers. In some embodiments, controller 1532 receives signals 1596 from IR sensor 1595 based on reflected infrared signals 1594 from a target illuminated by IR light that is part of output beam 1544. In some embodiments, the infrared laser light is added for night-vision applications. In some embodiments, output beam 1544 primarily outputs IR light until a target is sensed from the return reflected light 1594, and then controller 1532 turns on the RGB lasers to output visible light in output beam 1544 to illuminated the detected target (e.g., a person walking on a dark street). Other aspects of spotlight 1502 are as described of FIG. 15A. In order to provide better illumination for viewing and camera detection, optional despeckling optics 1585 are added, which include one or more vibrating, oscillating and/or rotating diffusers. Since, in some embodiments, laser light source 1502 has a very small divergence, the range of operation is extended. The RGB and IR can also be set by the control electronics 1532 as appropriate. In some embodiments, for example, when a target is detected by sensor 1595 using reflected IR signals from the IR illumination in beam 1544, visible RGB beam can be activated illuminating the target with visible light. In some embodiments, system 1520 is a vehicle, or mounted to or part of a vehicle, optionally as part of the headlight system.

In some embodiments, variations and combinations of the figures described above are used, optionally including others of the embodiments above such as diffusers, angled reflectors, to produce smaller systems and/or further combining of the beams to provide better etendue and beam power with or in smaller beam cross-sectional areas.

In any of the above-described embodiments, the laser-light output can have undesirable speckles. In some embodiments, the present invention provides a combined system in which the laser-light outputs of the above embodiments are further processed by one or more rotating, wobbling or vibrating diffusers (or variations thereof), which remove or further reduce undesirable laser speckle from the light.

In some embodiments, arranging two RRGB laser arrays 180 degrees from one another and facing one another improves wire-ability, heatsink cooling, and reduction in size of the system.

In some embodiments, the output color is changed by adjusting the intensity of light output of each color using the current control of the system.

In some embodiments, the components are arranged to provide minimum volume required, and with the output optical axis near the center of gravity of the system so that the system of lasers, combiners and/or homogenizers can be used in various applications where rotations and movements are required. The components are the same as those shown in the various figures above combined forming a complete system. Heat sinks and heat pipes are also provided for removing heat from the laser banks. The heat pipes carry heat away from the laser banks efficiently to larger and more efficient heat exchangers (not shown here) using refrigeration, fins with fans, etc. In some embodiments, turning mirrors (e.g., in some embodiments, mirrors that reflect the beams at right angles) are also used to configure the light paths such that the volume is smaller, making the system more compact. Other arrangements can also be made according to the system requirements.

In some embodiments, the present invention provides an apparatus that includes: a first plurality of lasers emitting a first plurality of parallel input laser beams, each having a first color, propagating in a first direction and spaced apart by a first beam-to-beam spacing and having a first total cross-sectional area; a second plurality of lasers emitting a second plurality of parallel input laser beams of one or more colors, other than the first color, propagating in a second direction and spaced apart by a second beam-to-beam spacing and having a second total cross-sectional area; a beam combiner that combines the first plurality of parallel input laser beams and the second plurality of parallel input laser beams into a first plurality of output laser beams having a cross-sectional area less than the first total cross-sectional area plus the second total cross-sectional area; and first homogenizer optics configured to combine the first plurality of laser beams into a single homogenized light beam.

In some embodiments, the beam combiner includes a first wavelength-selective filter-reflector configured to transmit the first plurality of parallel input laser beams and to reflect the second plurality of parallel input laser beams such that each of the first plurality of output laser beams is a coaxial combination of one of the first plurality of parallel input laser beams with a corresponding one of the second plurality of parallel input laser beams.

In some embodiments, the first plurality of lasers and the second plurality of lasers are arranged along a straight line such that the first plurality of parallel input laser beams and the second first plurality of parallel input laser beams are propagating parallel to one another in a single plane, and the first plurality of parallel input laser beams impinge on a first face of the first wavelength-selective filter-reflector, and the beam combiner further includes a reflector that reflects the second plurality of parallel input laser beams to impinge on a second face of the first wavelength-selective filter-reflector.

Some embodiments further include a third plurality of lasers emitting a third plurality of parallel input laser beams, each having the first color, propagating in a third direction and spaced apart by a third beam-to-beam spacing and having a third total cross-sectional area; a fourth plurality of lasers emitting a fourth plurality of parallel input laser beams of one or more colors, other than the first color, propagating in a fourth direction and spaced apart by a fourth beam-to-beam spacing and having a fourth total cross-sectional area; wherein the beam combiner includes a second wavelength-selective filter-reflector configured to reflect the third plurality of parallel input laser beams and to transmit the fourth plurality of parallel input laser beams to form a second plurality of output laser beams each of which is a coaxial combination of one of the third plurality of parallel input laser beams with a corresponding one of the fourth plurality of parallel input laser beams, wherein the first plurality of lasers and the second plurality of lasers are arranged along a straight line such that the first plurality of parallel input laser beams and the second first plurality of parallel input laser beams are parallel to one another in a single plane, wherein the third plurality of lasers and the fourth plurality of lasers are arranged along a straight line such that the third plurality of parallel input laser beams and the fourth first plurality of parallel input laser beams are parallel to one another in a single plane, wherein the first plurality of parallel input laser beams are transmitted through, and the third plurality of parallel input laser beams are reflected by, the first wavelength-selective filter-reflector to coaxially form the first plurality of output beams.

Some embodiments further include a third plurality of lasers emitting a third plurality of parallel input laser beams all having a third color different than the first color, propagating in a third direction and spaced apart by a third beam-to-beam spacing and having a third total cross-sectional area, wherein the beam combiner includes a second wavelength-selective filter-reflector configured to transmit the first plurality of parallel input laser beams and the second plurality of parallel input laser beams and to reflect the third plurality of parallel input laser such that each of the first plurality of output laser beams is a coaxial combination of one of the first plurality of parallel input laser beams with a corresponding one of the second plurality of parallel input laser beams and with a corresponding one of the third plurality of parallel input laser beams.

In some embodiments, the first homogenizer optics includes a light pipe and a focusing optic configured to focus the first plurality of output laser beams onto an input end of the light pipe.

In some embodiments, the first homogenizer optics includes a first fused fiber bundle, and wherein the first plurality of output laser beams are directed onto an input end of the fused fiber bundle from plurality of different angles relative to an optical axis of the first fused fiber bundle.

In some embodiments, the first homogenizer optics includes a focusing lens and a first fused fiber bundle, and wherein the first plurality of output laser beams are focused by the lens onto an input end of the first fused fiber bundle from plurality of different angles relative to an optical axis of the fused fiber bundle such that output light from the first fused fiber bundle forms a plurality of concentric rings each having light from beams entering the input end of the first fused fiber bundle from different angles.

In some embodiments, the first homogenizer optics includes a focusing lens, a first fused fiber bundle, a light pipe and a diffuser, and wherein the first plurality of output laser beams are focused by the lens onto an input end of the first fused fiber bundle from plurality of different angles relative to an optical axis of the fused fiber bundle such that output light from the first fused fiber bundle is directed through the light pipe and the diffuser.

In some embodiments, the first homogenizer optics includes a focusing lens, a first diffuser adjacent the lens, and a second diffuser located at a focal distance from the lens, and the first plurality of output laser beams are focused by the lens through the first diffuser onto an input face of the second diffuser from plurality of different angles relative to an optical axis.

In some embodiments, the first homogenizer optics includes a first fused fiber bundle, a first light pipe, a second fused fiber bundle, and a second light pipe, and the first plurality of output laser beams are directed onto an input face of the first fused fiber bundle, output light from the first fused fiber bundle is passed through the first light pipe into an input face of the second fused fiber bundle, and output light from the second fused fiber bundle is passed through the second light pipe and exits as the single homogenized light beam.

In some embodiments, the first homogenizer optics includes a first fused fiber bundle having a first optical axis, an input face and an output face at least one of which is at a non-perpendicular angle to the first optical axis, a first light pipe, a second fused fiber bundle having a second optical axis, an input face and an output face at least one of which is at a non-perpendicular angle to the second optical axis, and a second light pipe, and wherein the first plurality of output laser beams are directed onto an input face of the first fused fiber bundle, output light from the first fused fiber bundle is passed through the first light pipe into an input face of the second fused fiber bundle, and output light from the second fused fiber bundle is passed through the second light pipe and exits as the single homogenized light beam.

In some embodiments, the first homogenizer optics includes a first fused fiber bundle having a first optical axis, an input face and an output face each of which is perpendicular to the first optical axis, a second fused fiber bundle having a second optical axis, an input face and an output face each of which is perpendicular to the second optical axis, wherein the second optical axis is oriented at a non-zero angle to the first optical axis, and wherein the first plurality of output laser beams are directed onto an input face of the first fused fiber bundle, output light from the first fused fiber bundle is directed into an input face of the second fused fiber bundle, and output light from the second fused fiber bundle exits as the single homogenized light beam.

In some embodiments, the first homogenizer optics includes a first fused fiber bundle that has an optical axis and a first light pipe that has an input face and an output face, wherein the output face is non-perpendicular to the optical axis, and wherein the first plurality of output laser beams are directed onto an input face of the first fused fiber bundle, output light from the first fused fiber bundle is passed through the first light pipe into an input face of the second fused fiber bundle, and output light from the second fused fiber bundle is passed through the second light pipe and exits through the output face of the first light pipe.

In some embodiments, the first homogenizer optics includes a first fused fiber bundle that has an optical axis, a first light pipe that has an input face and an output face, wherein the output face is non-perpendicular to the optical axis, a second fused fiber bundle, a second light pipe and a diffuser, wherein the first plurality of output laser beams are directed onto an input face of the first fused fiber bundle, output light from the first fused fiber bundle is passed through the first light pipe into an input face of the second fused fiber bundle, and output light from the second fused fiber bundle is passed through the second light pipe and exits through the output face of the second light pipe.

In some embodiments, the first homogenizer optics includes a first fused fiber bundle that has an optical axis, a first light pipe that has an input face and an output face wherein the output face of the first light pipe is non-perpendicular to the optical axis, a second fused fiber bundle, a second light pipe that has an input face and an output face, and a diffuser, wherein the first plurality of output laser beams are directed onto an input face of the first fused fiber bundle, output light from the first fused fiber bundle is passed through the first light pipe into an input face of the second fused fiber bundle, and output light from the second fused fiber bundle is passed through the second light pipe and exits through the output face of the second light pipe and through the diffuser.

In some embodiments, the first homogenizer optics includes a first fused fiber bundle that has an optical axis, a first light pipe that has an input face and an output face wherein the output face of the first light pipe is non-perpendicular to the optical axis, a second fused fiber bundle, a second light pipe that has an input face and an output face wherein the output face of the second light pipe is non-perpendicular to the optical axis, a third light pipe, and a diffuser, wherein the first plurality of output laser beams are directed onto an input face of the first fused fiber bundle, output light from the first fused fiber bundle is passed through the first light pipe into an input face of the second fused fiber bundle, output light from the second fused fiber bundle is passed through the second light pipe into an input face of the third fused fiber bundle, and output light from the third fused fiber bundle is passed through the third light pipe and exits through the output face of the third light pipe and through the diffuser.

Some embodiments further include a third plurality of parallel input laser beams, each having the first color, propagating in a third direction and spaced apart by a third beam-to-beam spacing and a third total cross-sectional area, wherein the beam combiner includes a slotted reflector plate having a plurality of reflecting stripes alternating with a plurality of transparent stripes, and wherein the first plurality of parallel input laser beams are transmitted through the plurality of transparent stripes and the third plurality of parallel input laser beams are reflected by the plurality of reflecting stripes to be parallel to the transmitted first plurality of parallel input laser beams.

Some embodiments further include: a third plurality of parallel input laser beams, each having the first color, propagating in a third direction and spaced apart by a third beam-to-beam spacing and a third first total cross-sectional area; a fourth plurality of parallel input laser beams, each having a fourth color, propagating in a fourth direction and spaced apart by a fourth beam-to-beam spacing and a fourth total cross-sectional area; wherein the beam combiner includes: a slotted reflector plate having a plurality of reflecting stripes alternating with a plurality of transparent stripes, wherein the first plurality of parallel input laser beams are transmitted through the plurality of transparent stripes and the third plurality of parallel input laser beams are reflected by the plurality of reflecting stripes to be parallel to the transmitted first plurality of parallel input laser beams; a first wavelength-selective filter-reflector configured to reflect the second plurality of parallel input laser beams and pass the fourth plurality of parallel input laser beams to form coaxial intermediate laser beams each having light from the reflected second plurality of parallel input laser beams and the passed fourth plurality of parallel input laser beams; a second wavelength-selective filter-reflector configured to reflect the coaxial intermediate laser beams and pass the first and third plurality of beams coming from the slotted reflector plate; a third wavelength-selective filter-reflector, oriented at right angles to the second wavelength-selective filter-reflector, and configured to transmit the coaxial intermediate laser beams and reflect the first and third plurality of beams coming from the slotted reflector plate such that all of the beams from the second and third wavelength-selective filter-reflectors are parallel to one another; a light pipe having an input face and an output face; focusing optics configured to focus all of the beams from the second and third wavelength-selective filter-reflectors into the input face of the light pipe, and collimating optics configured to collimate light from the output face of the light pipe.

In some embodiments, the first optics includes a first stepped reflector configured to reflect the first plurality of parallel laser beams first reflected beams propagating in a first reflected direction with a first-reflected-beam beam-to-beam spacing that is smaller than the first beam-to-beam spacing.

In some embodiments, the first optics includes a first stepped reflector configured to reflect the first plurality of parallel laser beams as first reflected beams propagating in first reflected direction a second beam-to-beam spacing that is smaller than the first beam-to-beam spacing, and the apparatus further includes: a second plurality of lasers that output a second plurality of parallel laser beams propagating in a second direction and spaced apart by the first beam-to-beam spacing; and second optics that includes a second stepped reflector configured to reflect the second plurality of parallel laser beams as second reflected beams propagating in the second direction with a second beam-to-beam spacing that is smaller than the first beam-to-beam spacing, wherein the first reflected beams and the second reflected beams are interleaved and parallel to one another.

In some embodiments, the first optics includes a first stepped reflector configured to reflect the first plurality of parallel laser beams as first reflected beams propagating in a first reflected direction with a second beam-to-beam spacing that is smaller than the first beam-to-beam spacing, and the apparatus further includes: a second plurality of lasers that output a second plurality of parallel laser beams propagating in a second direction and spaced apart by the first beam-to-beam spacing, wherein the second direction is parallel to the first direction; second optics that includes a second stepped reflector configured to reflect the second plurality of parallel laser beams as second reflected beams propagating in the first reflected direction with a second beam-to-beam spacing that is smaller than the first beam-to-beam spacing, wherein the first reflected beams and the second reflected beams are interleaved and parallel to one another; a third plurality of lasers that output a third plurality of parallel laser beams propagating in a third direction and spaced apart by the first beam-to-beam spacing, wherein the third direction is antiparallel to the first and second directions; and third optics that includes a third stepped reflector configured to reflect the third plurality of parallel laser beams as third reflected beams propagating in the first reflected direction with a third beam-to-beam spacing that is smaller than the first beam-to-beam spacing, wherein the first, second and third reflected beams are interleaved and parallel to one another.

In some embodiments, the first optics includes a first stepped reflector configured to reflect the first plurality of parallel laser beams as first reflected beams propagating in a first reflected direction with a second beam-to-beam spacing that is smaller than the first beam-to-beam spacing, and the apparatus further includes: a second plurality of lasers that output a second plurality of parallel laser beams propagating in a second direction and spaced apart by the first beam-to-beam spacing, wherein the second direction is parallel to the first direction; second optics that includes a second stepped reflector configured to reflect the second plurality of parallel laser beams as second reflected beams propagating in the first reflected direction with a second beam-to-beam spacing that is smaller than the first beam-to-beam spacing, wherein the first reflected beams and the second reflected beams are interleaved and parallel to one another; a third plurality of lasers that output a third plurality of parallel laser beams propagating in a third direction and spaced apart by the first beam-to-beam spacing, wherein the third direction is antiparallel to the first and second directions; and third optics that includes a third stepped reflector configured to reflect the third plurality of parallel laser beams as third reflected beams propagating in the first reflected direction with a third beam-to-beam spacing that is smaller than the first beam-to-beam spacing, wherein the first, second and third reflected beams are interleaved and parallel to one another.

In some embodiments, the first optics includes a first stepped reflector configured to reflect the first plurality of parallel laser beams as first reflected beams propagating in a first reflected direction with a second beam-to-beam spacing that is smaller than the first beam-to-beam spacing, and the apparatus further includes: a second plurality of lasers that output a second plurality of parallel laser beams propagating in a second direction and spaced apart by the first beam-to-beam spacing, wherein the second direction is parallel to the first direction; second optics that includes a second stepped reflector configured to reflect the second plurality of parallel laser beams as second reflected beams propagating in the first reflected direction with a second beam-to-beam spacing that is smaller than the first beam-to-beam spacing, wherein the first reflected beams and the second reflected beams are interleaved and parallel to one another; a third plurality of lasers that output a third plurality of parallel laser beams propagating in a third direction and spaced apart by the first beam-to-beam spacing, wherein the third direction is antiparallel to the first and second directions; and third optics that includes a third stepped reflector configured to reflect the third plurality of parallel laser beams as third reflected beams propagating in the first reflected direction with a third beam-to-beam spacing that is smaller than the first beam-to-beam spacing, wherein the first, second and third reflected beams are interleaved and parallel to one another, and wherein the first, second and third pluralities of laser beams have different first, second and third colors, respectively.

In some embodiments, the first optics includes a first transparent stepped reflector configured to internally reflect the first plurality of parallel laser beams to form first reflected beams propagating internally within the first transparent stepped reflector in a first reflected direction with a first-reflected-beam beam-to-beam spacing that is smaller than the first beam-to-beam spacing.

In some embodiments, the first plurality of parallel laser beams include at least four laser beams propagating in parallel in a single plane, wherein the first optics includes a first stepped reflector configured to reflect the first plurality of parallel laser beams to form first reflected beams in a two-dimensional array of beams propagating in a first reflected direction with a first-reflected-beam beam-to-beam spacing that is smaller than the first beam-to-beam spacing.

In some embodiments, the first plurality of parallel laser beams each have an elliptical cross-section shape having a first width in a first cross-section direction that is narrower than a second width in a second cross-section direction perpendicular to the first cross-section direction, and the first optics includes a first stepped reflector configured to reflect the first plurality of parallel laser beams as first reflected beams propagating in a second direction with a second beam-to-beam spacing that is smaller than the second width.

In some embodiments, the first plurality of parallel laser beams each have an elliptical cross-section shape having a first width in a first cross-section direction that is narrower than a second width in a second cross-section direction perpendicular to the first cross-section direction, and the first optics includes a first stepped reflector configured to reflect the first plurality of parallel laser beams as first reflected beams propagating in a second direction with a second beam-to-beam spacing that is equal to the first width.

In some embodiments, the first plurality of parallel laser beams each have an elliptical cross-section shape having a first width in a first cross-section direction that is narrower than a second width in a second cross-section direction perpendicular to the first cross-section direction, and the first optics includes a first stepped reflector configured to reflect the first plurality of parallel laser beams as first reflected beams in a two-dimensional array of beams propagating in a second direction.

Some embodiments further include a rotary actuator to selectively change an altitude angle of the homogenized light beam; a rotary actuator to selectively change an azimuth angle of the homogenized light beam; and a controller to selectively change hue, saturation, and intensity of the homogenized light beam.

Some embodiments further include a laser that outputs an infrared laser beam that becomes part of the homogenized light beam; an infrared sensor that is configured to receive reflected infrared light of the homogenized light beam and to generate a detection signal; a rotary actuator to selectively change an altitude angle of the homogenized light beam; a rotary actuator to selectively change an azimuth angle of the homogenized light beam; and a controller to selectively change hue, saturation, and intensity of the homogenized light beam based at least in part on the detection signal.

In some embodiments, the present invention provides an apparatus that includes a plurality of laser arrays, each laser array of the plurality of laser arrays having a plurality of lasers emitting laser light of substantially the same color in a substantially parallel direction, wherein the color of the light of each of the plurality of laser arrays is different than the color of light of the others of the plurality of laser arrays; and optics configured to combine the different colored laser light from the plurality of laser arrays into a homogenized light beam.

In some embodiments, the present invention provides a method for combining laser beams, wherein the method includes: reflecting a first plurality of asymmetric laser beams of a first color using step-mirror reflectors to obtain a first set of parallel reflected beams of the first color, wherein each of the first plurality of laser beams has an asymmetric cross-sectional area having a shorter cross-section width and a longer cross-section width, and wherein the first set of parallel reflected beams has a beam-to-beam spacing equal to the shorter cross-section width; reflecting a plurality of asymmetric laser beams of a second color using step-mirror reflectors to obtain a second set of parallel reflected beams of the second color, wherein each of the second plurality of laser beams has an asymmetric cross-sectional area having a shorter cross-section width and a longer cross-section width, and wherein the second set of parallel reflected beams has a beam-to-beam spacing equal to the shorter cross-section width; using a dichroic mirror to combine the combined beams of the first color with the combined beams of the second color to obtain coaxially combined beams of the first and second color; reflecting a plurality of asymmetric laser beams of a third color using step-mirror reflectors to obtain combined beams of the third color; using a dichroic mirror to combine the combined beams of the third color with the combined beams of the first and second color to obtain combined beams of the first, second and third color; and passing the combined beams of the first, second and third color through a light pipe to obtain a single collinear output beam, for applications in projectors and stage-lighting light sources.

In some embodiments, the present invention provides method for combining laser beams, wherein the method includes receiving a first plurality of parallel input laser beams, each having a first color, propagating in a first direction and spaced apart by a first beam-to-beam spacing and having a first total cross-sectional area; receiving a second plurality of lasers emitting a second plurality of parallel input laser beams of one or more colors, other than the first color, propagating in a second direction and spaced apart by a second beam-to-beam spacing and having a second total cross-sectional area; combining the first plurality of parallel input laser beams and the second plurality of parallel input laser beams into a first plurality of output laser beams having a cross-sectional area less than the first total cross-sectional area plus the second total cross-sectional area; and homogenizing the first plurality of output laser beams into a single homogenized light beam.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1. (canceled)

2. The apparatus of claim 17, wherein the beam combiner includes a first wavelength-selective filter-reflector configured to transmit the first plurality of parallel input laser beams and to reflect the second plurality of parallel input laser beams such that each of the first plurality of output laser beams is a coaxial combination of one of the first plurality of parallel input laser beams with a corresponding one of the second plurality of parallel input laser beams.

3. (canceled)

4. The apparatus of claim 2, further comprising:
a third plurality of lasers emitting a third plurality of parallel input laser beams, each having the first color, propagating in a third direction and spaced apart by a third beam-to-beam spacing and having a third total cross-sectional area;
a fourth plurality of lasers emitting a fourth plurality of parallel input laser beams of one or more colors, other than the first color, propagating in a fourth direction and spaced apart by a fourth beam-to-beam spacing and having a fourth total cross-sectional area;
wherein the beam combiner includes a second wavelength-selective filter-reflector configured to reflect the third plurality of parallel input laser beams and to transmit the fourth plurality of parallel input laser beams to form a second plurality of output laser beams each of which is a coaxial combination of one of the third plurality of parallel input laser beams with a corresponding one of the fourth plurality of parallel input laser beams,
wherein the first plurality of lasers and the second plurality of lasers are arranged along a straight line such that the first plurality of parallel input laser beams and the second first plurality of parallel input laser beams are parallel to one another in a single plane,
wherein the third plurality of lasers and the fourth plurality of lasers are arranged along a straight line such that the third plurality of parallel input laser beams and the fourth first plurality of parallel input laser beams are parallel to one another in a single plane,
wherein the first plurality of parallel input laser beams are transmitted through, and the third plurality of parallel input laser beams are reflected by, the first wavelength-selective filter-reflector to coaxially form the first plurality of output beams.

5. The apparatus of claim 2, further comprising:
a third plurality of lasers emitting a third plurality of parallel input laser beams all having a third color different than the first color, propagating in a third direction and spaced apart by a third beam-to-beam spacing and having a third total cross-sectional area,
wherein the beam combiner includes a second wavelength-selective filter-reflector configured to transmit the first plurality of parallel input laser beams and the second plurality of parallel input laser beams and to reflect the third plurality of parallel input laser such that each of the first plurality of output laser beams is a coaxial combination of one of the first plurality of parallel input laser beams with a corresponding one of the second plurality of parallel input laser beams and with a corresponding one of the third plurality of parallel input laser beams.

6. The apparatus of claim 17, wherein the first homogenizer optics includes a light pipe and a focusing optic configured to focus the first plurality of output laser beams onto an input end of the light pipe.

7. The apparatus of claim 17, wherein the first plurality of output laser beams are directed onto an input end of the fused fiber bundle from plurality of different angles relative to an optical axis of the first fused fiber bundle.

8. The apparatus of claim 17, wherein the first homogenizer optics includes a focusing lens, and wherein the first plurality of output laser beams are focused by the focusing lens onto an input end of the first fused fiber bundle from plurality of different angles relative to an optical axis of the fused fiber bundle such that output light from the first fused fiber bundle forms a plurality of concentric rings each having light from beams entering the input end of the first fused fiber bundle from different angles.

9. The apparatus of claim 17, wherein the first homogenizer optics includes a focusing lens, and a diffuser, and wherein the first plurality of output laser beams are focused by the focusing lens onto the input end of the first fused fiber bundle from plurality of different angles relative to an optical axis of the fused fiber bundle such that output light from the first fused fiber bundle is directed through the first light pipe and the diffuser.

10.-16. (canceled)

17. An apparatus comprising:
a first plurality of lasers emitting a first plurality of parallel input laser beams, each having a first color, propagating in a first direction and spaced apart by a first beam-to-beam spacing and having a first total cross-sectional area;
a second plurality of lasers emitting a second plurality of parallel input laser beams of one or more colors, other than the first color, propagating in a second direction and spaced apart by a second beam-to-beam spacing and having a second total cross-sectional area;
a beam combiner that combines the first plurality of parallel input laser beams and the second plurality of parallel input laser beams into a first plurality of output laser beams having a cross-sectional area less than the first total cross-sectional area plus the second total cross-sectional area; and
first homogenizer optics configured to combine the first plurality of laser beams into a single homogenized light beam;
wherein the first homogenizer optics includes a first fused fiber bundle that has an optical axis, a first light pipe that has an input face and an output face wherein the output face of the first light pipe is non-perpendicular to the optical axis, a second fused fiber bundle, a second light pipe that has an input face and an output face wherein the output face of the second light pipe is non-perpendicular to the optical axis, a third light pipe, and a diffuser,
wherein the first plurality of output laser beams are directed onto an input face of the first fused fiber bundle, output light from the first fused fiber bundle is passed through the first light pipe into an input face of the second fused fiber bundle, output light from the second fused fiber bundle is passed through the second light pipe into an input face of the third fused fiber bundle, and output light from the third fused fiber bundle is passed through the third light pipe and exits through the output face of the third light pipe and through the diffuser.

18.-19. (canceled)

20. The apparatus of claim 17, wherein the first optics includes a first stepped reflector configured to reflect the first plurality of parallel laser beams first reflected beams propagating in a first reflected direction with a first-reflected-beam beam-to-beam spacing that is smaller than the first beam-to-beam spacing.

21. The apparatus of claim 17, wherein the first optics includes a first stepped reflector configured to reflect the first plurality of parallel laser beams as first reflected beams propagating in first reflected direction a second beam-to-beam spacing that is smaller than the first beam-to-beam spacing, the apparatus further comprising:
a second plurality of lasers that output a second plurality of parallel laser beams propagating in a second direction and spaced apart by the first beam-to-beam spacing; and
second optics that includes a second stepped reflector configured to reflect the second plurality of parallel laser beams as second reflected beams propagating in the second direction with a second beam-to-beam spacing that is smaller than the first beam-to-beam spacing, wherein the first reflected beams and the second reflected beams are interleaved and parallel to one another.

22. The apparatus of claim 17, wherein the first optics includes a first stepped reflector configured to reflect the first plurality of parallel laser beams as first reflected beams propagating in a first reflected direction with a second beam-to-beam spacing that is smaller than the first beam-to-beam spacing, the apparatus further comprising:
a second plurality of lasers that output a second plurality of parallel laser beams propagating in a second direction and spaced apart by the first beam-to-beam spacing, wherein the second direction is parallel to the first direction;
second optics that includes a second stepped reflector configured to reflect the second plurality of parallel laser beams as second reflected beams propagating in the first reflected direction with a second beam-to-beam spacing that is smaller than the first beam-to-beam spacing, wherein the first reflected beams and the second reflected beams are interleaved and parallel to one another;
a third plurality of lasers that output a third plurality of parallel laser beams propagating in a third direction and spaced apart by the first beam-to-beam spacing, wherein the third direction is antiparallel to the first and second directions; and
third optics that includes a third stepped reflector configured to reflect the third plurality of parallel laser beams as third reflected beams propagating in the first reflected direction with a third beam-to-beam spacing that is smaller than the first beam-to-beam spacing, wherein the first, second and third reflected beams are interleaved and parallel to one another.

23. The apparatus of claim 17, wherein the first optics includes a first stepped reflector configured to reflect the first plurality of parallel laser beams as first reflected beams propagating in a first reflected direction with a second beam-to-beam spacing that is smaller than the first beam-to-beam spacing, the apparatus further comprising:
a second plurality of lasers that output a second plurality of parallel laser beams propagating in a second direction and spaced apart by the first beam-to-beam spacing, wherein the second direction is parallel to the first direction;
second optics that includes a second stepped reflector configured to reflect the second plurality of parallel laser beams as second reflected beams propagating in the first reflected direction with a second beam-to-beam spacing that is smaller than the first beam-to-beam spacing, wherein the first reflected beams and the second reflected beams are interleaved and parallel to one another;
a third plurality of lasers that output a third plurality of parallel laser beams propagating in a third direction and spaced apart by the first beam-to-beam spacing, wherein the third direction is antiparallel to the first and second directions; and
third optics that includes a third stepped reflector configured to reflect the third plurality of parallel laser beams as third reflected beams propagating in the first reflected direction with a third beam-to-beam spacing that is smaller than the first beam-to-beam spacing, wherein the first, second and third reflected beams are interleaved and parallel to one another.

24. The apparatus of claim 17, wherein the first optics includes a first stepped reflector configured to reflect the first plurality of parallel laser beams as first reflected beams propagating in a first reflected direction with a second beam-to-beam spacing that is smaller than the first beam-to-beam spacing, the apparatus further comprising:
a second plurality of lasers that output a second plurality of parallel laser beams propagating in a second direction and spaced apart by the first beam-to-beam spacing, wherein the second direction is parallel to the first direction;
second optics that includes a second stepped reflector configured to reflect the second plurality of parallel laser beams as second reflected beams propagating in the first reflected direction with a second beam-to-beam spacing that is smaller than the first beam-to-beam spacing, wherein the first reflected beams and the second reflected beams are interleaved and parallel to one another;
a third plurality of lasers that output a third plurality of parallel laser beams propagating in a third direction and spaced apart by the first beam-to-beam spacing, wherein the third direction is antiparallel to the first and second directions; and
third optics that includes a third stepped reflector configured to reflect the third plurality of parallel laser beams as third reflected beams propagating in the first reflected direction with a third beam-to-beam spacing that is smaller than the first beam-to-beam spacing, wherein the first, second and third reflected beams are interleaved and parallel to one another, and wherein the first, second and third pluralities of laser beams have different first, second and third colors, respectively.

25. The apparatus of claim 17, wherein the first optics includes a first transparent stepped reflector configured to internally reflect the first plurality of parallel laser beams to form first reflected beams propagating internally within the first transparent stepped reflector in a first reflected direction with a first-reflected-beam beam-to-beam spacing that is smaller than the first beam-to-beam spacing.

26. The apparatus of claim 17, wherein the first plurality of parallel laser beams include at least four laser beams propagating in parallel in a single plane, wherein the first optics includes a first stepped reflector configured to reflect the first plurality of parallel laser beams to form first reflected beams in a two-dimensional array of beams propagating in a first reflected direction with a first-reflected-beam beam-to-beam spacing that is smaller than the first beam-to-beam spacing.

27. The apparatus of claim 17,
wherein the first plurality of parallel laser beams each have an elliptical cross-section shape having a first width in a first cross-section direction that is narrower than a second width in a second cross-section direction perpendicular to the first cross-section direction, and
wherein the first optics includes a first stepped reflector configured to reflect the first plurality of parallel laser beams as first reflected beams propagating in a second direction with a second beam-to-beam spacing that is smaller than the second width.

28. The apparatus of claim 17,
wherein the first plurality of parallel laser beams each have an elliptical cross-section shape having a first width in a first cross-section direction that is narrower than a second width in a second cross-section direction perpendicular to the first cross-section direction, and
wherein the first optics includes a first stepped reflector configured to reflect the first plurality of parallel laser beams as first reflected beams propagating in a second direction with a second beam-to-beam spacing that is equal to the first width.

29. The apparatus of claim 17,
wherein the first plurality of parallel laser beams each have an elliptical cross-section shape having a first width in a first cross-section direction that is narrower than a second width in a second cross-section direction perpendicular to the first cross-section direction, and
wherein the first optics includes a first stepped reflector configured to reflect the first plurality of parallel laser beams as first reflected beams in a two-dimensional array of beams propagating in a second direction.

30. The apparatus of claim 17, further comprising:
a rotary actuator to selectively change an altitude angle of the homogenized light beam;
a rotary actuator to selectively change an azimuth angle of the homogenized light beam; and
a controller to selectively change hue, saturation, and intensity of the homogenized light beam.

31. The apparatus of claim 17, further comprising:
a laser that outputs an infrared laser beam that becomes part of the homogenized light beam;
an infrared sensor that is configured to receive reflected infrared light of the homogenized light beam and to generate a detection signal;
a rotary actuator to selectively change an altitude angle of the homogenized light beam;
a rotary actuator to selectively change an azimuth angle of the homogenized light beam; and
a controller to selectively change hue, saturation, and intensity of the homogenized light beam based at least in part on the detection signal.

32.-34. (canceled)
